(19) United States
(12) Patent Application Publication
(10) Pub. No.: US 2010/0091207 A1
(43) Pub. Date: Apr. 15, 2010

(54) Three-dimensional image system, display device, shutter operation synchronizing device of three-dimensional image system, shutter operation synchronizing method of three-dimensional image system, and electronic device

(75) Inventors: Hiroshi Hasegawa, Kanagawa (JP); Teppei Isobe, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/585,128

(22) Filed: Sep. 4, 2009

(30) Foreign Application Priority Data
Oct. 10, 2008 (JP) 2008-264547

(51) Int. Cl. G02F 1/1335

(52) U.S. Cl. 349/15

(57) ABSTRACT

A three-dimensional image system includes: a display device including a pixel array section, a driving circuit section, and a display end timing extracting section; a transmitting section; and wearable means including a receiving section, a pair of shutter mechanisms, and a shutter driving section.

### BACKGROUND OF THE INVENTION

1. Field of the Invention

The invention described in the present specification relates to a technique of synchronizing the shutter operation of wearable means worn by a user to view a three-dimensional image with changes of display frames. Incidentally, the invention proposed in the present specification has an aspect as a three-dimensional image system, a display device, a shutter operation synchronizing device of a three-dimensional image system, a shutter operation synchronizing method of a three-dimensional image system, and an electronic device.

2. Description of the Related Art

To this day, the display panel module has spread as a display device for images taken from a single visual point (which images will hereinafter be referred to as “two-dimensional images”). These days, however, development of display devices capable of displaying an image taken using a binocular parallax (which image will hereinafter be referred to as a “three-dimensional image”) and making a user perceive the image as a stereoscopic image is under way. However, two-dimensional images constitute overwhelmingly large amounts of existing contents.

It is thus considered that display panel modules in the future will need a mechanism capable of displaying both two-dimensional images and three-dimensional images.

FIG. 1 shows an example of construction of an imaging system capable of displaying both a two-dimensional image and a three-dimensional image. This imaging system 1 is suitable for use when a two-dimensional image and a three-dimensional image are desired to be displayed in a same screen size.

The imaging system 1 includes an image reproducer 3, a display device 5, a stereo sync phase adjuster 7, an infrared light emitting section 9, and eyeglasses 11 provided with liquid crystal shutters. Of these components, the image reproducer 3 is a video device having a function of reproducing both two-dimensional images and three-dimensional images. The image reproducer 3 includes not only so-called image reproducing devices but also set-top boxes and computers. The image reproducer 3 outputs image date to the display device 5.

In addition, at a time of display of a three-dimensional image, the image reproducer 3 outputs a changing signal for synchronizing the shutter changing operation of the eyeglasses 11 provided with the liquid crystal shutters with timing of changing display images to the stereo sync phase adjuster 7. The changing signal in this case will hereinafter be referred to as a “shutter changing signal.” Incidentally, the shutter changing signal is generated in timing synchronized with a vertical synchronizing signal of image data output from the image reproducer 3. That is, the image data output from the image reproducer 3 and the shutter changing signal are controlled in optimum timing.

The display device 5 is a device for outputting the input image data. The display device 5 includes not only so-called television receivers but also monitors.

The stereo sync phase adjuster 7 is a circuit device for adjusting the phase of the shutter changing signal at the time of display of the three-dimensional image. As described above, the phase of the shutter changing signal is optimized with the image data at a point in time that the image data is output from the image reproducer 3.

However, because of image processing performed in the display device 5, the changing phase of the display images becomes different from the phase at the point in time of the output of the image reproducer 3. In addition, a time length demanded for the image processing differs depending on the nature of the processing performed in the image reproducer 3. Therefore the stereo sync phase adjuster 7 is disposed to enable the user himself/herself to make adjustment so as to make the phase of the shutter changing signal an optimum phase.

The infrared light emitting section 9 is a circuit device for transmitting the shutter changing signal supplied from the stereo sync phase adjuster 7 to the eyeglasses 11 provided with the liquid crystal shutters through an infrared ray. The eyeglasses 11 provided with the liquid crystal shutters are one of wearable means (accessories) that a user is demanded to wear at a time of display of a three-dimensional image. Of course, the user does not need to wear the eyeglasses 11 provided with the liquid crystal shutters at a time of display of a two-dimensional image.

FIG. 2 shows an image of operation of the eyeglasses 11 provided with the liquid crystal shutters. In the figure, a picture in which a hollow inside of a frame is shown indicates an opened state of the liquid crystal shutter, that is, a state in which external light can pass through. A picture in which a hatched inside of a frame is shown indicates a closed state of the liquid crystal shutter, that is, a state in which external light does not pass through.

As shown in FIG. 2, during display of a three-dimensional image, the two liquid crystal shutters are not simultaneously set in an opened state, but only one of the liquid crystal shutters is controlled to be in an opened state in such a manner as to be interlocked with the changing of a displayed image. Specifically, only the liquid crystal shutter for the left eye is controlled to be in an opened state during display of an image for the left eye, and only the liquid crystal shutter for the right eye is controlled to be in an opened state during display of an image for the right eye. The imaging system 1 makes it possible to view a stereoscopic image by the complementary operation of opening and closing the liquid crystal shutters.

FIG. 3 shows an equivalent circuit of an electronic circuit part of the eyeglasses 11 provided with the liquid crystal shutters. The eyeglasses 11 provided with the liquid crystal shutters include a battery 21, an infrared light receiving section 23, a shutter driving section 25, and the liquid crystal shutters 27 and 29.

The battery 21 is a lightweight and small battery such as a button battery, for example. The infrared light receiving section 23 is for example an electronic part attached to a front part of the eyeglasses to receive infrared light on which the shutter changing signal is superimposed.

The shutter driving section 25 is an electronic part that performs switching control on the opening and closing of the liquid crystal shutter 27 for the right eye and the liquid crystal shutter 29 for the left eye in such a manner as to be synchronized with display images on the basis of the received shutter changing signal.

### SUMMARY OF THE INVENTION

The time length of the processing of the display device 5 may differ according to the device. In addition, optimum processing operations may differ depending on the contents of an image to be displayed and the brightness of an ambient environment. Moreover, these processing operations may be optimized automatically within the display device for improvement in display quality. Thus the timing of output of the shutter changing signal can be varied.

However, in the case of the existing three-dimensional image system, the user himself/herself viewing the displayed image needs to adjust the phase of the shutter changing signal by manual operation. It is, however, difficult to force a general user to perform this adjusting operation.

Accordingly, the inventor et al. propose a three-dimensional image system including the following devices.

(a) A display device including a pixel array section having pixels arranged in a form of a matrix, a driving circuit section configured to drive the pixel array section to display an input image, and a display end timing extracting section configured to extract display end timing corresponding to a last output row of each frame from a driving signal of the driving circuit section when an image for a left eye and an image for a right eye, the image for the left eye and the image for the right eye corresponding to a binocular parallax, are displayed alternately in frame units in the pixel array section

(b) A transmitting section configured to transmit a display changing signal for the image for the left eye and the image for the right eye with the extracted display end timing as a trigger

(c) A receiving section configured to receive the display changing signal, a pair of shutter mechanisms disposed in front of eyes of a wearer, and a shutter driving section configured to drive the shutter mechanisms so as to enable only observation by the eye corresponding to an image being displayed on a basis of the display changing signal

Incidentally, the above-described driving circuit section desirably operates in common driving timing set such that display periods of adjacent frames do not overlap each other when either of a two-dimensional image and a three-dimensional image is displayed.

When the driving circuit section includes a first driving section configured to drive a signal line formed in the pixel array section, a second driving section configured to control writing of a potential appearing in the signal line to a pixel, and a third driving section configured to control supplying and stopping of one of a driving power and a driving current to the pixel, it is desirable to satisfy the following condition.

It is desirable that the second driving section control writing timing on a basis of a first scan clock, and that the third driving section control timing of supply of one of the driving power and the driving current on a basis of a second scan clock having a higher speed than the first scan clock.

Further, it is desirable that a waiting time from completion of writing of a signal potential to a start of lighting in each horizontal line be set such that the waiting time of a first horizontal line in which the writing of a signal potential is completed first is longest, the waiting time of a second horizontal line in which the writing of a signal potential is completed last is shortest, and length of the waiting time of each horizontal line positioned between the first horizontal line and the second horizontal line is changed linearly according to positional relation to the first horizontal line and the second horizontal line.

Incidentally, the display end timing is desirably extracted on a basis of timing of stopping supply of one of driving current and driving power to the last output row of the pixel array section. Alternatively, the display end timing is desirably extracted on a basis of timing of a start of output of an entire-surface black screen inserted at a time of changing between the image for the left eye and the image for the right eye.

In an embodiment of the invention proposed by the inventor et al., the display device generates the display changing signal according to actual display timing. Specifically, the display device generates the display changing signal with the display end timing corresponding to the last output row of each frame as a trigger. Thus, phase adjustment by manual operation as in the existing techniques can be obviated. Anyone can therefore enjoy the three-dimensional image system regardless of age or expertise. Of course, the embodiment can make the timing of output of the display changing signal automatically follow a variation in the display end timing which variation accompanies a change in display mode. Thus, excellent image quality can be maintained at all times.

### BRIEF DESCRIPTION OF THE DRAWINGS

FIG. 1 is a conceptual diagram of an imaging system capable of displaying both a two-dimensional image and a three-dimensional image;

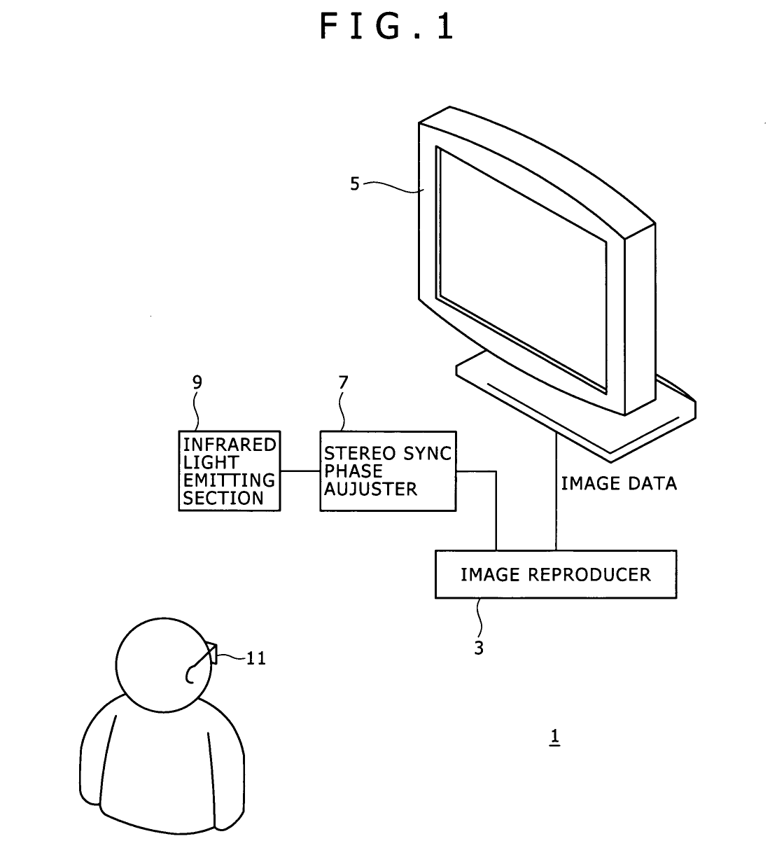

FIG. 2 is a diagram of assistance in explaining a mode of operation of eyeglasses provided with liquid crystal shutters used to view a three-dimensional image;

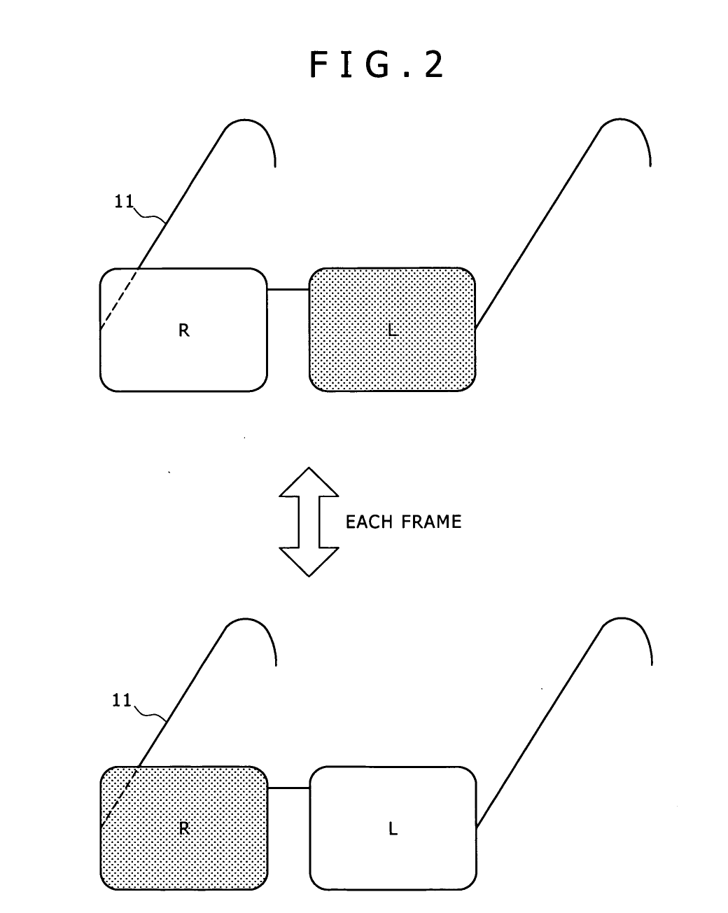

FIG. 3 is a diagram showing an equivalent circuit of an electronic function part of the eyeglasses provided with the liquid crystal shutters;

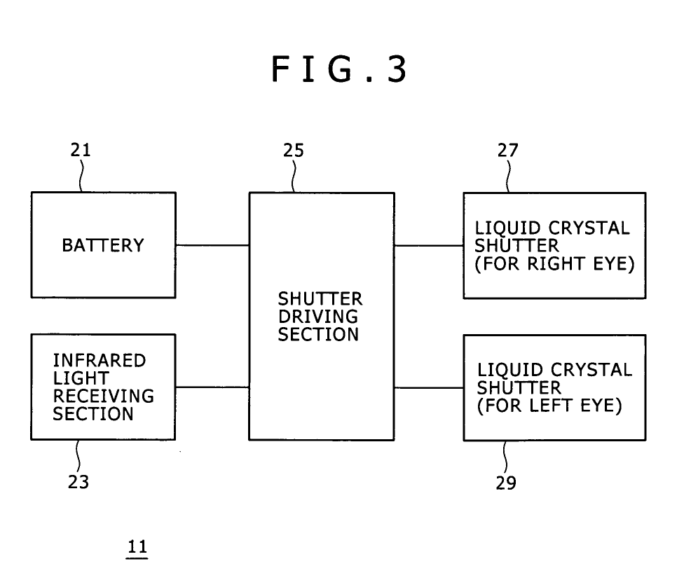

FIG. 4 is a conceptual diagram of an imaging system capable of displaying both a two-dimensional image and a three-dimensional image (embodiment);

FIG. 5 is a conceptual diagram of an imaging system capable of displaying both a two-dimensional image and a three-dimensional image (embodiment);

FIG. 6 is a diagram showing an example of external configuration of an organic EL panel module;

FIG. 7 is a diagram of assistance in explaining an example of the system structure of the organic EL panel module;

FIG. 8 is a diagram of assistance in explaining an arrangement of pixels;

FIG. 9 is a diagram of assistance in explaining an example of pixel structure of a sub-pixel;

FIG. 10 is a diagram showing an example of circuit configuration of a signal line driving section;

FIG. 11 is a diagram showing an example of the driving waveform of a signal line;

FIG. 12 is a diagram showing an example of circuit configuration of a writing control line driving section;

FIG. 13 is a diagram showing an example of circuit configuration of a power supply line driving section;

FIGS. 14A and 14B are diagrams of assistance in explaining driving techniques for a two-dimensional image and a three-dimensional image;

FIGS. 15A, 15B, 15C, 15D, and 15E are diagrams showing relation between an example of driving waveforms and internal potentials of a sub-pixel;

FIGS. 16A, 16B, 16C, 16D, and 16E are diagrams showing relation between an example of driving waveforms and internal potentials of a sub-pixel;

FIGS. 17A, 17B, 17C, and 17D are diagrams of assistance in explaining relation between waiting times to a start of lighting and horizontal lines;

FIGS. 18A, 18B, 18C, and 18D are diagrams of assistance in explaining a relation between processing timing by horizontal line and display periods at a time of display of a three-dimensional image (embodiment);

FIG. 19 is a diagram showing an equivalent circuit of a sub-pixel corresponding to a time of lighting operation;

FIG. 20 is a diagram showing the equivalent circuit of the sub-pixel corresponding to a time of extinguishing operation during a non-emission period;

FIG. 21 is a diagram showing the equivalent circuit of the sub-pixel corresponding to a time of initializing operation during the non-emission period;

FIG. 22 is a diagram showing the equivalent circuit of the sub-pixel corresponding to the time of initializing operation during the non-emission period;

FIG. 23 is a diagram showing the equivalent circuit of the sub-pixel corresponding to a time of threshold value correcting operation during the non-emission period;

FIG. 24 is a diagram showing the equivalent circuit of the sub-pixel corresponding to a point in time of completion of the threshold value correcting operation;

FIG. 25 is a diagram showing the equivalent circuit of the sub-pixel corresponding to operation from the completion of the threshold value correcting operation to a start of writing of a signal potential;

FIG. 26 is a diagram showing the equivalent circuit of the sub-pixel corresponding to a time of the operation of writing the signal potential;

FIG. 27 is a diagram showing the equivalent circuit of the sub-pixel corresponding to a time of mobility correcting operation;

FIG. 28 is a diagram showing the equivalent circuit of the sub-pixel corresponding to a waiting time to a start of lighting;

FIG. 29 is a diagram showing the equivalent circuit of the sub-pixel corresponding to a time after the start of the lighting;

FIGS. 30A and 30B are diagrams of assistance in explaining driving technique of the existing system;

FIG. 31 is a diagram of assistance in explaining the system structure of the organic EL panel module;

FIG. 32 is a diagram showing an example of internal configuration of a driving condition setting section;

FIG. 33 is a diagram showing an example of internal configuration of a one-frame average luminance level calculating block;

FIG. 34 is a diagram of assistance in explaining relation between peak luminance levels and each gradation luminance;

FIGS. 35A, 35B, and 35C are diagrams showing examples of setting of lighting period length;

FIGS. 36A, 36B, 36C, and 36D are diagrams of assistance in explaining a relation between processing timing by horizontal line and display periods at a time of display of a three-dimensional image;

FIGS. 37A, 37B, 37C, and 37D are diagrams of assistance in explaining a relation between processing timing by horizontal line and display periods at a time of display of a three-dimensional image;

FIG. 38 is a diagram of assistance in explaining another example of configuration of the display end timing extracting section;

FIG. 39 is a diagram of assistance in explaining another example of circuit configuration of the sub-pixel;

FIG. 40 is a diagram of assistance in explaining another example of circuit configuration of the sub-pixel;

FIG. 41 is a diagram showing an example of conceptual configuration of an electronic device;

FIG. 42 is a diagram showing a product example of an electronic device; and

FIG. 43 is a diagram showing a product example of an electronic device.

### DETAILED DESCRIPTION OF THE PREFERRED EMBODIMENTS

An example of the best mode of the invention will hereinafter be described in the following order.

### (A) Example of Construction of Image System

### (B) Example of External Appearance of Display Panel Module

### (C) First Embodiment of Display Panel Module

### (D) Second Embodiment of Display Panel Module

### (E) Other Embodiments

Incidentally, well known or publicly known techniques in a pertinent technical field are applied to parts not specifically shown or described in the present specification. In addition, embodiments described below are each an embodiment of the invention, and the present invention is not limited to these embodiments.

### (A) Example of Construction of Image System

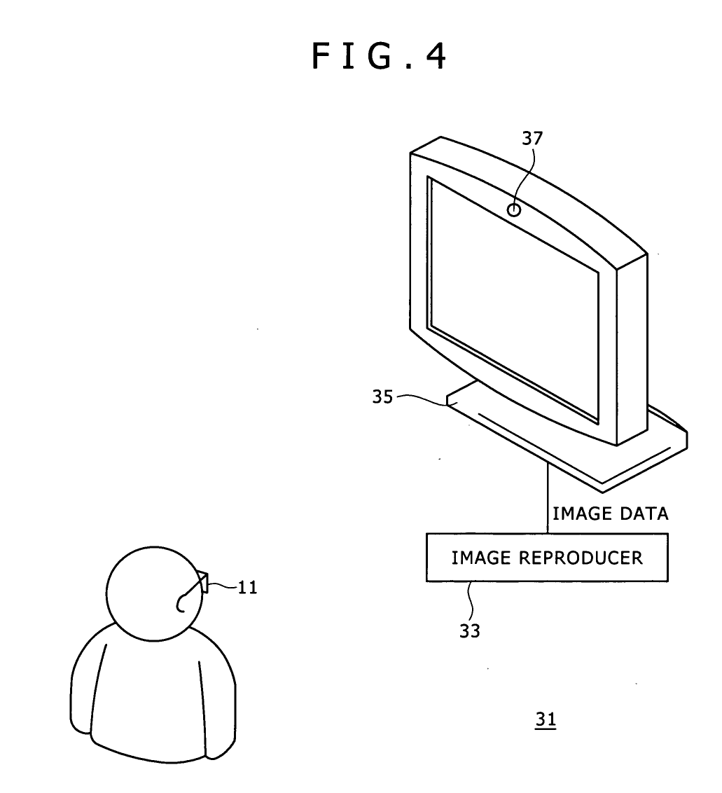

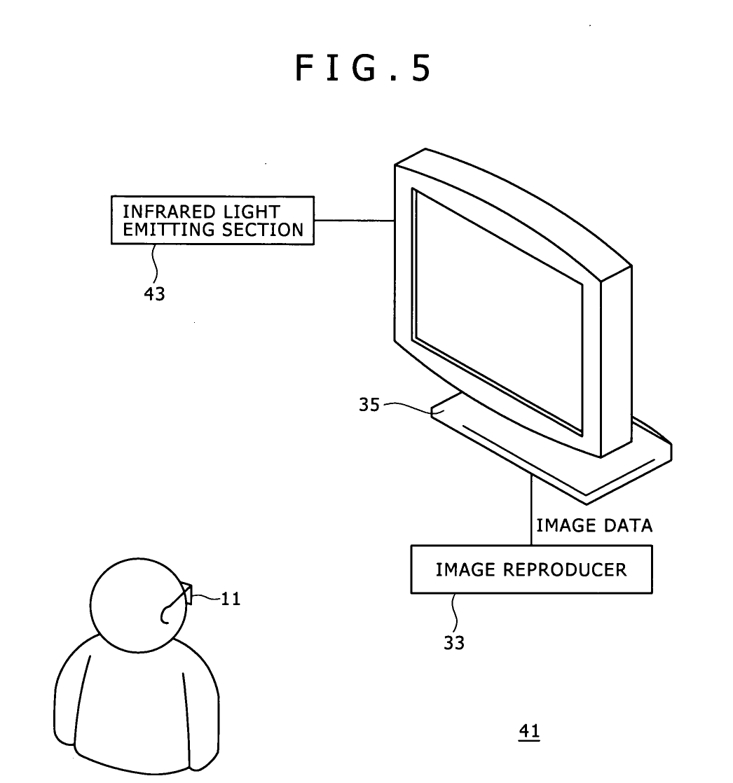

FIG. 4 and FIG. 5 show an example of construction of an image system proposed by the inventor et al.

The image system 31 shown in FIG. 4 includes an image reproducer 33, a display device 35, an infrared light emitting section 37, and eyeglasses 11 provided with a liquid crystal shutter.

The image system 41 shown in FIG. 5 includes an image reproducer 33, a display device 35, an infrared light emitting section 43, and eyeglasses 11 provided with a liquid crystal shutter.

A difference between the image system shown in FIG. 4 and the image system shown in FIG. 5 is whether the infrared light emitting section is attached as a part of a casing of the display device or connected in a state of being external to the display device. Incidentally, the infrared light emitting section corresponds to a “transmitting section” in claims. A shutter changing signal corresponds to a “display changing signal” in claims.

The image systems proposed by the inventor et al. generate the shutter changing signal on the basis of a driving signal of a pixel array section. That is, a function of generating the shutter changing signal is incorporated into the display device 35. This is a difference from the existing system. Therefore, in the case of the image systems proposed by the inventor et al., output wiring of the image reproducer 33 is only image data wiring connected to the display device 35. Thus, the number of circuits of the image reproducer 33 and the number of pieces of wiring of the image reproducer 33 in the image systems proposed by the inventor et al. can be reduced as compared with the existing system.

Incidentally, the display device 35 includes a display panel module formed by mounting a pixel array section and a driving circuit therefor on a panel, as will be described later, a system controlling section, and an operating input section.

The infrared light emitting sections 37 and 43 are each formed by a general-purpose infrared emitter. Of course, the infrared emitter of the infrared light emitting section 43 is housed in a dedicated casing.

### (B) Example of External Appearance of Display Panel Module

Description will next be made of an example of external appearance of the display panel module forming the display device. In the present specification, the display panel module is used in two senses. One is a display panel module in which a pixel array section and a driving circuit (for example a signal line driving section, a writing control line driving section, and a power supply control line driving section) are formed on a substrate using a semiconductor process. The other is a display panel module in which a driving circuit manufactured as an application-specific IC (Integrated Circuit) is mounted on a substrate where a pixel array section is formed.

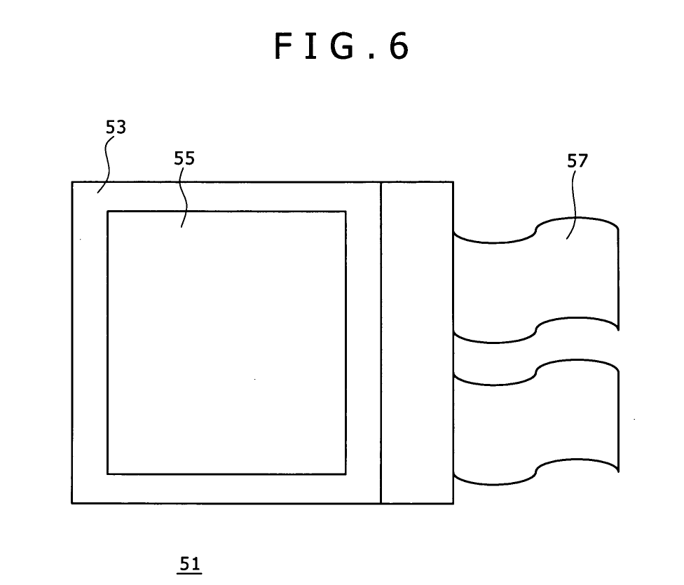

FIG. 6 shows an example of external configuration of a display panel module. The display panel module 51 has a structure formed by laminating a counter substrate 55 to a pixel array section forming region of a supporting substrate 53.

The supporting substrate 53 is formed by glass, plastic, or another base material. The counter substrate 55 also has glass, plastic, or another transparent member as a base material.

The counter substrate 55 is a member for sealing the surface of the supporting substrate 53 with a sealing material interposed between the counter substrate 55 and the supporting substrate 53.

Incidentally, it suffices to secure substrate transparency only on a light emitting side, and another substrate side may be an opaque substrate. In addition, the display panel module 21 has an FPC (Flexible Printed Circuit) 57 for inputting an external signal and driving power.

### (C) First Embodiment of Display Panel Module

An example of a mode of an organic EL panel module having organic EL elements arranged in the form of a matrix in a pixel array section will be described in the following.

### (C-1) System Configuration

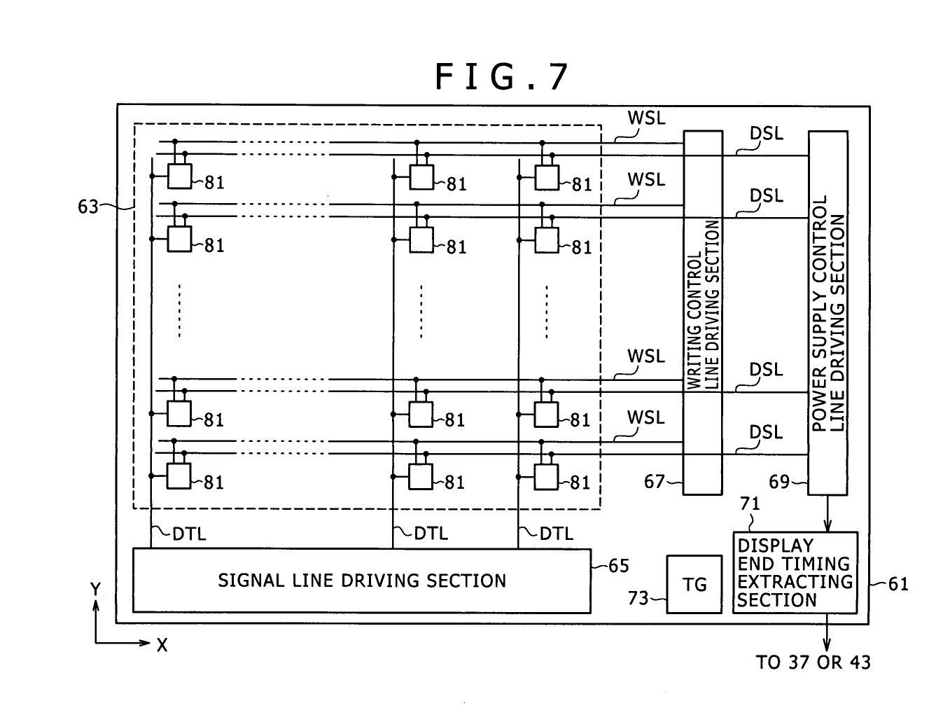

FIG. 7 shows an example of system configuration of an organic EL panel module 61 according to the present embodiment.

The organic EL panel module 61 shown in FIG. 7 includes a pixel array section 63 as well as a signal line driving section 65, a writing control line driving section 67, a power supply control line driving section 69, a display end timing extracting section 71 and a timing generator 73, which are a driving circuit for driving the pixel array section 63.

### (a) Pixel Array Section

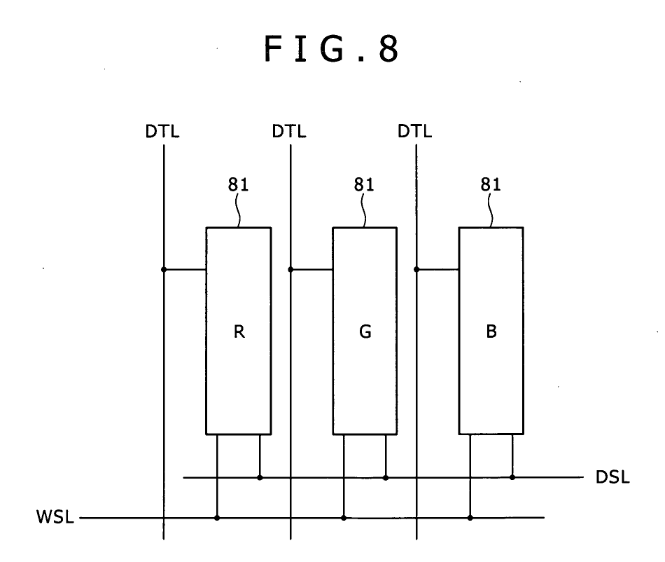

In the case of the present embodiment, in the pixel array section 63, one pixel forming a white unit is arranged at a specified resolution in each of a vertical direction and a horizontal direction within a screen. FIG. 8 shows an example of arrangement structure of sub-pixels 81 forming a white unit. As shown in FIG. 8, the white unit is formed as an aggregate of an R (red) pixel 81, a G (green) pixel 81, and a B (blue) pixel 81.

Letting M be a vertical resolution of the pixel array section 63 and N be a horizontal resolution of the pixel array section 63, a total number of sub-pixels of the pixel array section 63 is given by M×N×3.

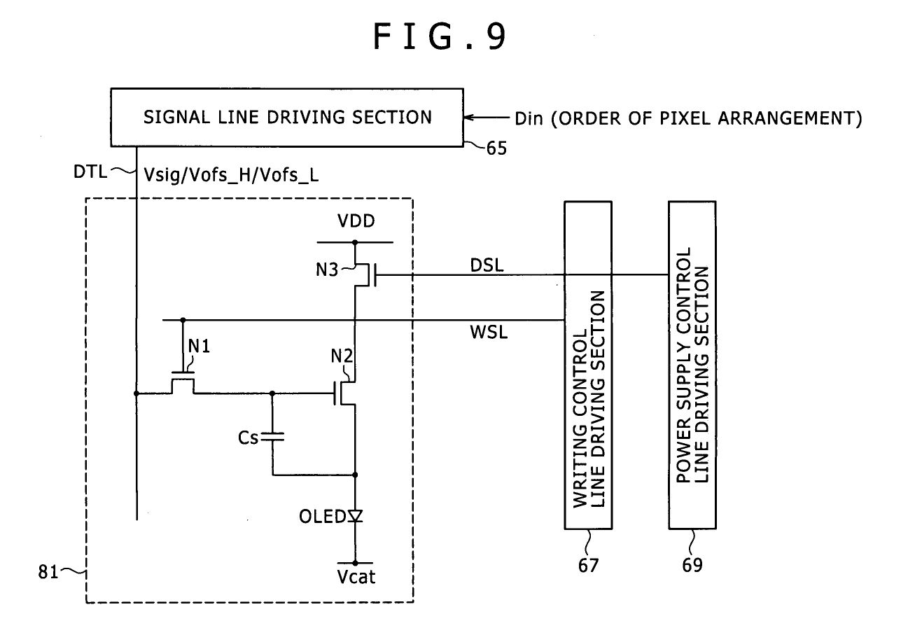

FIG. 9 shows a relation of connection between a sub-pixel 81 as a minimum unit of a pixel structure forming the pixel array section 63 and a driving circuit part of the sub-pixel 81.

In the present embodiment, as shown in FIG. 9, the sub-pixel 81 includes N-channel type thin film transistors N1, N2, and N3, a storage capacitor Cs for retaining gradation information, and an organic EL element OLED. Incidentally, the thin film transistor N1 is a switch element for controlling the writing of a potential appearing in a signal line DTL (which potential will hereinafter be referred to as a “signal line potential”). The thin film transistor N1 will hereinafter be referred to as a sampling transistor N1.

The thin film transistor N2 is a switch element for supplying a driving current of a magnitude corresponding to a potential retained by the storage capacitor Cs to the organic EL element OLED. The thin film transistor N2 will hereinafter be referred to as a driving transistor N2.

The thin film transistor N3 is a switch element for controlling the supply and the stopping of the supply of a driving voltage VDD to the driving transistor N2. The thin film transistor N3 will hereinafter be referred to as a power supply controlling transistor N3.

### (b) Configuration of Signal Line Driving Section

The signal line driving section 65 is a circuit device for driving the signal line DTL. Each signal line DTL is arranged so as to extend in a vertical direction (Y-direction) of the screen, and 3×N signal lines DTL are arranged in a horizontal direction (X-direction) of the screen. In the present embodiment, the signal line driving section 65 drives the signal line DTL by three values of a characteristic correcting potential Vofs_L, an initializing potential Vofs_H, and a signal potential Vsig.

Incidentally, the characteristic correcting potential Vofs_L is for example a potential corresponding to a black level of pixel gradation. The characteristic correcting potential Vofs_L is used for an operation of correcting variation in threshold voltage Vth of the driving transistor N2 (which operation will hereinafter be referred to as a threshold value correcting operation).

The initializing potential Vofs_H is a potential for cancelling a voltage retained by the storage capacitor Cs. An operation of thus cancelling the voltage retained by the storage capacitor Cs will hereinafter be referred to as an initializing operation.

Incidentally, the initializing potential Vofs_H is set higher than a maximum value that can be assumed by the signal potential Vsig corresponding to a pixel gradation. Thereby the retained voltage can be cancelled regardless of the signal potential Vsig given in a preceding frame period.

The signal line driving section 65 in the present embodiment operates in same driving timing both at a time of display of a two-dimensional image and at a time of display of a three-dimensional image.

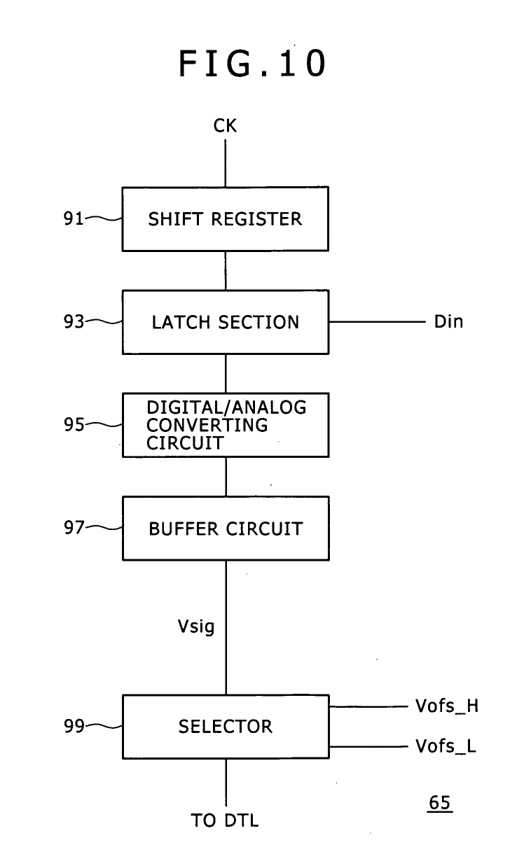

FIG. 10 shows an example of internal configuration of the signal line driving section 65. The signal line driving section 65 includes a shift register 91, a latch section 93, a digital/analog converting circuit 95, a buffer circuit 97, and a selector 99.

The shift register 91 is a circuit device for giving timing of capturing pixel data Din on the basis of a clock signal CK. In the present embodiment, the shift register 91 is formed by at least 3×N delay stages corresponding to the number of signal lines DTL. Thus, the clock signal CK has 3×N pulses within one horizontal scanning period.

The latch section 93 is a storage circuit for capturing the pixel data Din into a corresponding storage area on the basis of a timing signal output from the shift register 91.

The digital/analog converting circuit 95 is a circuit device for converting the pixel data Din captured into the latch section 93 to an analog signal voltage Vsig. Incidentally, the conversion characteristics of the digital/analog converting circuit 95 are defined by an H-level reference potential Vref_H and an L-level reference potential Vref_L.

The buffer circuit 97 is a circuit device for converting a signal amplitude to a signal level suitable for panel driving.

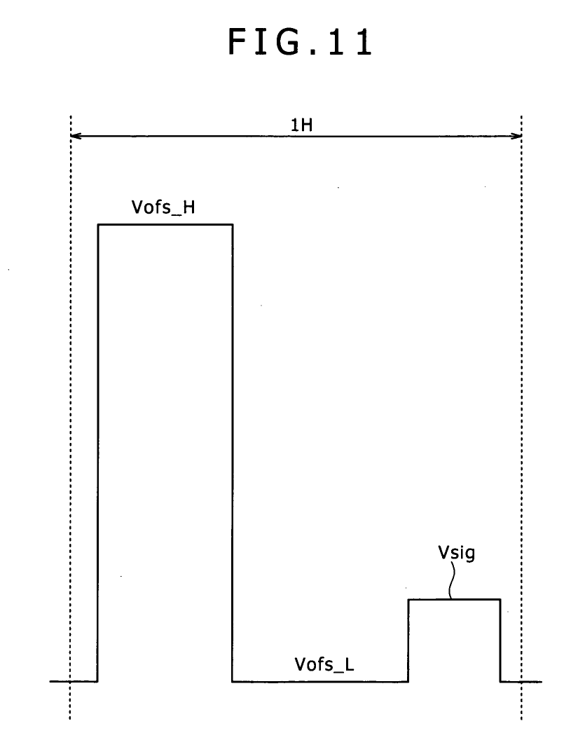

The selector 99 is a circuit device for selectively outputting one of the signal potential Vsig corresponding to a pixel gradation, the threshold value correcting potential Vofs_L, and the initializing potential Vofs_H within one horizontal scanning period. FIG. 11 shows an example of output of the signal line potentials by the selector 99. In the present embodiment, the selector 99 outputs the initializing potential Vofs_H, the threshold value correcting potential Vofs_L, and the signal potential Vsig in this order.

### (c) Configuration of Writing Control Line Driving Section

The writing control line driving section 67 is a driving device for controlling the writing of a signal potential to the sub-pixel 81 on a line-sequential basis through a writing control line WSL. Incidentally, the writing control line WSL is arranged so as to extend in the horizontal direction (X-direction) of the screen, and M writing control lines WSL are arranged in the vertical direction (Y-direction) of the screen.

The writing control line driving section 67 also functions as a driving device specifying timing of performing an initializing operation, a threshold value correcting operation, a signal potential writing operation, and a mobility correcting operation in horizontal line units. The writing control line driving section 67 operates in same driving timing both at the time of display of a two-dimensional image and at the time of display of a three-dimensional image.

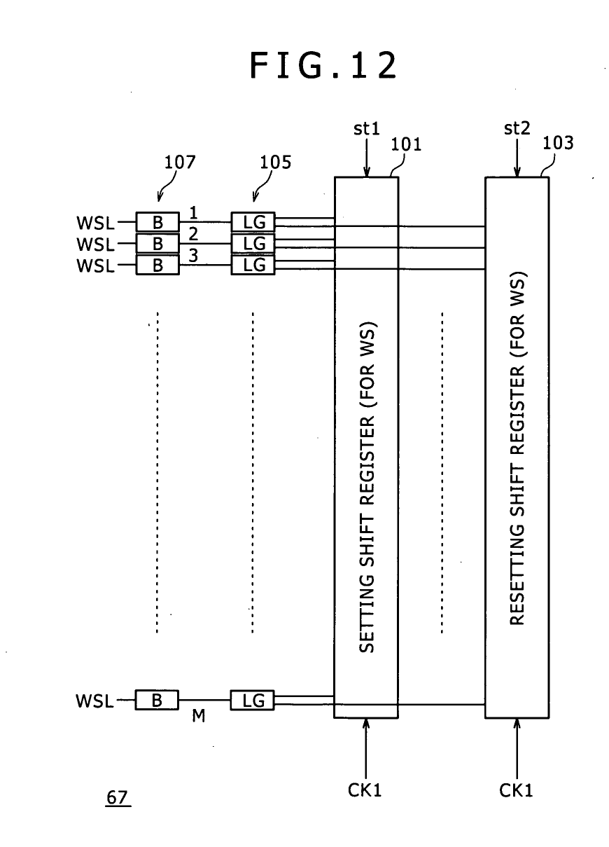

FIG. 12 shows an example of circuit configuration of the control line driving section 67. The control line driving section 67 is formed by a setting shift register 101, a resetting shift register 103, logic gates 105, and buffer circuits 107.

The setting shift register 101 is formed by M delay stages corresponding to the vertical resolution. The setting shift register 101 operates on the basis of a first shift clock CK1 synchronous with a horizontal scanning clock. Each time the first shift clock CK1 is input, the setting shift register 101 transfers a setting pulse to a next delay stage. The first shift clock CK1 in this case corresponds to a “first scan clock” in claims. Incidentally, transfer start timing is given by a start pulse st1.

The resetting shift register 103 is also formed by M delay stages corresponding to the vertical resolution. Similarly, the resetting shift register 103 operates on the basis of the first shift clock CK1 synchronous with the horizontal scanning clock. Each time the first shift clock CK1 is input, the resetting shift register 73 transfers a resetting pulse to a next delay stage. Transfer start timing is given by a start pulse st2.

The logic gates 105 are a circuit device for generating a pulse signal having a pulse width from the input of the setting pulse to the input of the resetting pulse. The logic gates 105 are arranged by the number of writing control lines WSL. Incidentally, when a plurality of writing timings need to be given within one horizontal scanning period, it suffices to obtain the waveform of a logical product of a pulse waveform giving the plurality of writing timings and the pulse signal defined by the setting pulse and the resetting pulse. In this case, the setting pulse and the resetting pulse have a role of identifying a horizontal line to which the plurality of writing timings are output.

The buffer circuits 107 are a circuit device for level-converting a control pulse at a logic level to a control pulse at a driving level. The buffer circuits 107 need to have a capability of simultaneously driving N sub-pixels connected to a writing control line WSL.

### (d) Configuration of Power Supply Control Line Driving Section

The power supply control line driving section 69 is a driving device for controlling the supply and the stop of the supply of a driving power VDD to the sub-pixel 81 through a power supply control line DSL. Incidentally, the power supply control line DSL is arranged so as to extend in the horizontal direction (X-direction) of the screen, and M power supply control lines DSL are arranged in the vertical direction (Y-direction) of the screen.

The power supply control line driving section 69 operates to supply the driving power VDD for periods of performance of threshold value correcting operation and mobility correcting operation in a non-emission period. Incidentally, this control operation is performed in synchronism with the writing control operation of the writing control line driving section 67. Thus, the operation of the power supply control line driving section 69 in the non-emission period is performed on the basis of the first shift clock CK1 synchronous with the horizontal scanning clock.

In addition, the power supply control line driving section 69 operates to supply the driving power VDD only for a period of lighting control of the organic EL element OLED in an emission period. In the present embodiment, the control operation in the emission period by the power supply control line driving section 69 is performed at a scan speed higher than a scan speed during the non-emission period. That is, the control operation is performed using a second shift clock CK2 having a higher speed than the first shift clock CK1. The second shift clock CK2 in this case corresponds to a “second scan clock” in claims.

The scan speed of the control pulse in the emission period is thus increased in order to compress the length of a period from a lighting start (display start) in an upper end part of the screen to a lighting end (display end) in a lower end part of the screen as compared with an existing technique. Incidentally, the higher a ratio of the second shift clock CK2 to the first shift clock CK1, the more the expansion of the emission period between a top and a bottom within the screen can be compressed.

In the present embodiment, the second shift clock CK2 is set to be 2.77 times the first shift clock CK1 (one horizontal scanning clock).

The power supply control line driving section 69 in the present embodiment also operates in same driving timing both at a time of display of a two-dimensional image and at a time of display of a three-dimensional image.

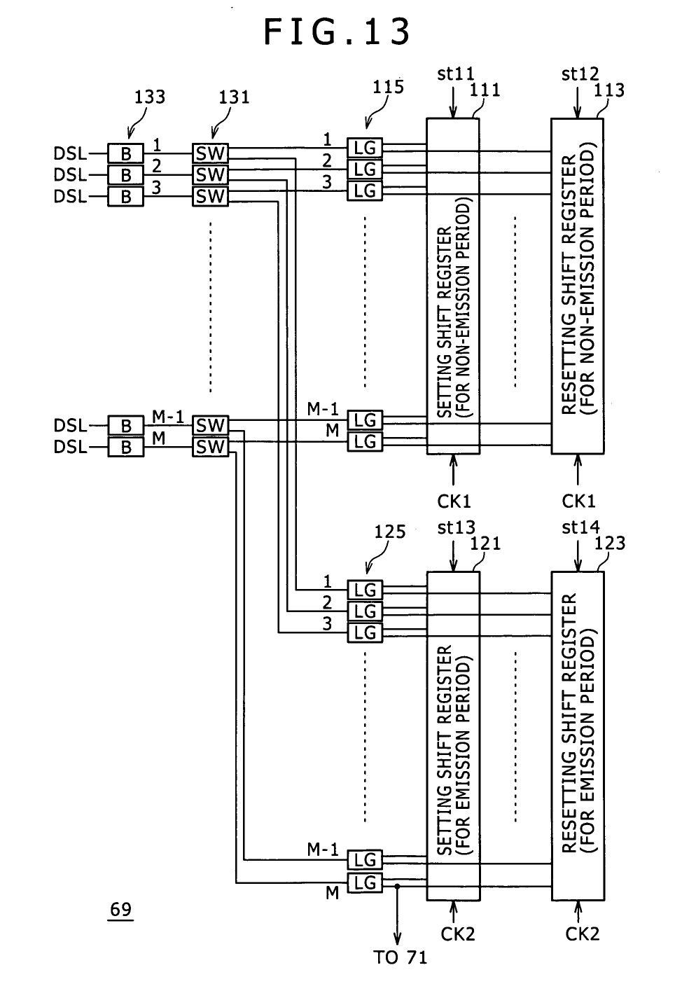

FIG. 13 shows an example of circuit configuration of the power supply control line driving section 69. The power supply control line driving section 69 includes a circuit stage for the non-emission period, a circuit stage for the emission period, a circuit stage for selectively outputting control pulses for these different periods, and a circuit stage for converting a control pulse at a logic level to a control pulse at a driving level.

Of the circuit parts, the circuit part for the non-emission period is formed by a setting shift register 111, a resetting shift register 113, and logic gates 115.

The setting shift register 111 is formed by M delay stages corresponding to the vertical resolution. The setting shift register 111 operates on the basis of the first shift clock CK1 synchronous with the horizontal scanning clock. Each time the first shift clock CK1 is input, the setting shift register 111 transfers a setting pulse to a next delay stage. Transfer start timing is given by a start pulse st11.

The resetting shift register 113 is also formed by M delay stages corresponding to the vertical resolution. Similarly, the resetting shift register 113 operates on the basis of the first shift clock CK1 synchronous with the horizontal scanning clock. Each time the first shift clock CK1 is input, the resetting shift register 113 transfers a resetting pulse to a next delay stage. Transfer start timing is given by a start pulse st12.

The logic gates 115 are a circuit device for generating a pulse signal having a pulse width from the input of the setting pulse to the input of the resetting pulse. The logic gates 115 are arranged by the number of power supply control lines DSL.

Incidentally, when an edge of the pulse signal is desired to be set in the middle of one horizontal scanning period, it suffices to obtain the waveform of a logical product of a pulse waveform giving the timing of the edge and the pulse signal generated by the setting pulse and the resetting pulse.

Similarly, the circuit part for the emission period is formed by a setting shift register 121, a resetting shift register 123, and logic gates 125.

The setting shift register 121 is formed by M delay stages corresponding to the vertical resolution. The setting shift register 121 operates on the basis of the second shift clock CK2 having a higher speed than the horizontal scanning clock. Each time the second shift clock CK2 is input, the setting shift register 121 transfers a setting pulse to a next delay stage. Transfer start timing is given by a start pulse st13.

The resetting shift register 123 is also formed by M delay stages corresponding to the vertical resolution. Similarly, the resetting shift register 123 operates on the basis of the second shift clock CK2 having a higher speed than the horizontal scanning clock. Each time the second shift clock CK2 is input, the resetting shift register 123 transfers a resetting pulse to a next delay stage. Transfer start timing is given by a start pulse st14.

The logic gates 125 are a circuit device for generating a pulse signal having a pulse width from the input of the setting pulse to the input of the resetting pulse. The logic gates 125 are arranged by the number of power supply control lines DSL.

Incidentally, when an edge of the pulse signal is desired to be set in the middle of one horizontal scanning period, it suffices to obtain the waveform of a logical product of a pulse waveform giving the timing of the edge and the pulse signal generated by the setting pulse and the resetting pulse.

The pulse signals from the circuit parts provided for these two process periods are selected by switch circuits 131. The switch circuits 131 select the pulse signals input from the logic gates 115 for the non-emission period, and select the pulse signals input from the logic gates 125 for the emission period. Incidentally, the selection of the pulse signals is changed by a changing signal not shown in the figure. Of course, the pulse signals of the logic gates 125 can also be used as the changing signal.

That is, a method of interlocking the changing of logic level of the logic gates 125 is adopted. Of course, when the pulse signals input from the logic gates 125 are changed to an H-level, the pulse signals are selected, and when the pulse signals are changed to an L-level, the pulse signals input from the logic gates 125 are selected.

Buffer circuits 133 are arranged in a stage succeeding the switch circuits 131. The buffer circuits 133 are a circuit device for level-converting a power supply control signal at a logic level to a power supply control signal at a driving level. The buffer circuits 133 need to have a capability of simultaneously driving N sub-pixels connected to a power supply control line DSL.

### (e) Configuration of Display End Timing Extracting Section 71

The display end timing extracting section 71 is a circuit device for extracting timing of an end of the display period of each image frame at the time of display of a three-dimensional image. As will be described later, the display period of each image frame is defined as a period from a start of light emission of a horizontal line situated in an uppermost stage of the pixel array section 63 to an end of light emission of a horizontal line situated in a lowermost stage of the pixel array section 63.

In this embodiment, the display end timing extracting section 71 is wired so as to monitor the output of a reset pulse providing timing of an end of an emission period of the horizontal line situated in the last stage of the pixel array section 63 or timing of a start of output of an entire-surface black screen. Specifically, an Mth piece of output wiring corresponding to the last output stage among pieces of output wiring extending from the resetting shift register 123 shown in FIG. 13 is branched into two pieces of wiring, and one of the two pieces of wiring is routed to an input terminal of the display end timing extracting section 71.

Timing in which the reset pulse appears at the input terminal (reset timing) corresponds to “display end timing” in claims.

When the display end timing extracting section 71 detects the reset pulse at the input terminal at the time of display of a three-dimensional image, the display end timing extracting section 71 outputs a display changing signal to the infrared light emitting section 37 or 43 using the reset pulse as a trigger.

Incidentally, in the case of FIG. 13, the display end timing extracting section 71 monitors the appearance of the reset pulse corresponding to the horizontal line situated in the last stage of the pixel array section 63. However, the display end timing extracting section 71 can also monitor a rear edge of a pulse signal output from the logic gate 125 situated in the following stage.

Similarly, the display end timing extracting section 71 can also monitor a pulse signal output from the switch circuit 131 corresponding to the horizontal line situated in the last stage of the pixel array section 63, or the display end timing extracting section 71 can also monitor a pulse signal output from the buffer circuit 133 situated in the following stage.

The display end timing extracting section 71 and the infrared light emitting section 37 or 43 in this case correspond to a “shutter synchronizing device” in claims. In addition, the operation of the display end timing extracting section 71 and the infrared light emitting section 37 or 43 corresponds to a “shutter synchronizing method.”

### (f) Configuration of Timing Generator 73

The timing generator 73 is a circuit device for generating timing control signals and clocks necessary to drive the organic EL panel module 61. The timing generator 73 generates for example the clock signal CK, the first shift clock CK1, the second shift clock CK2, the start pulses st1, st2, st11, st12, st13, and st14 and the like.

### (C-2) Driving Operation

### (a) Outline of Display Schedule

Description will be made below of the display schedule of the organic EL panel module 61 according to the present embodiment. In the present embodiment, a case where the organic EL panel module 61 is supplied with an image stream of 60 frames/second is assumed. That is, a case where both an image stream for a two-dimensional image and an image stream for a three-dimensional image are taken or generated at a rate of 60 frames/second is assumed.

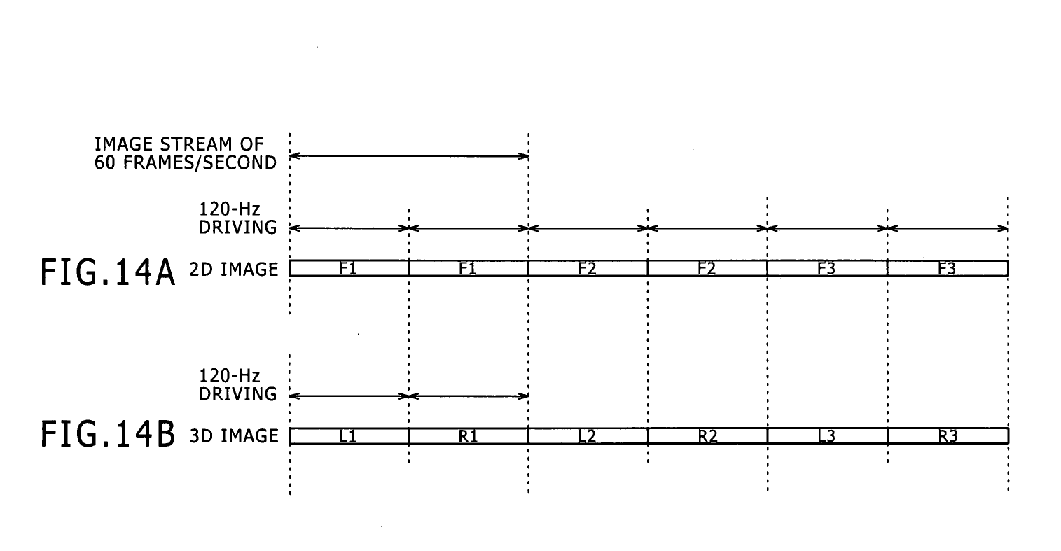

FIGS. 14A and 14B show the display schedules of image streams assumed in the present embodiment. As shown in FIGS. 14A and 14B, the present embodiment adopts a driving system that makes display at a rate of 120 frames/second irrespective of difference in kind of an input image stream. That is, a driving system that displays two frames in 1/60 [seconds] is adopted.

FIG. 14A is the display schedule of a two-dimensional image. In the case of a two-dimensional image, frame images of same image contents are displayed in a first half period and a second half period of a display period given in a unit of 1/60 [seconds]. That is, frame images are displayed twice each in such a manner as F1→F1→F2→F2→F3→F3→F4→F4 . . . . Of course, an image obtained by applying motion compensation to an input image may be inserted in the second half period of the display period. The insertion of an image obtained by motion compensation can enhance the display quality of the moving image. This display corresponds to a so-called double-speed display technique.

FIG. 14B is the display schedule of a three-dimensional image. In the case of a three-dimensional image, an image L for a left eye is displayed in a first half period of a display period given in a unit of 1/60 [seconds], and an image R for a right eye is displayed in a second half period of the display period. That is, images for the left eye and the right eye are displayed alternately in such a manner as L1→R1→L2→R2→L3→R3→L4→R4 . . . .

### (b) Outline of Driving Timing

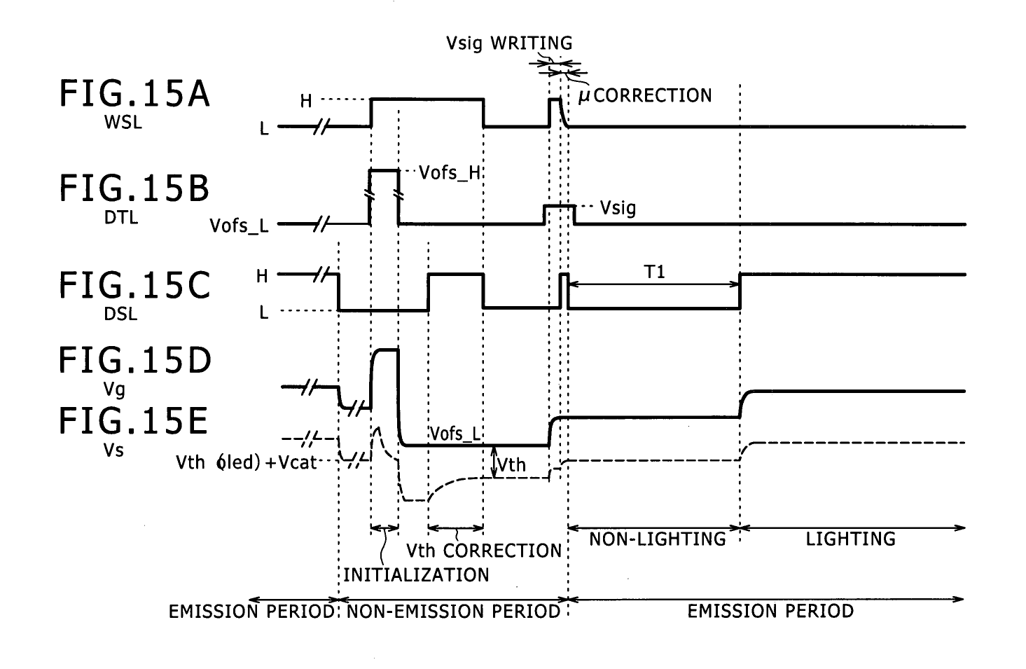

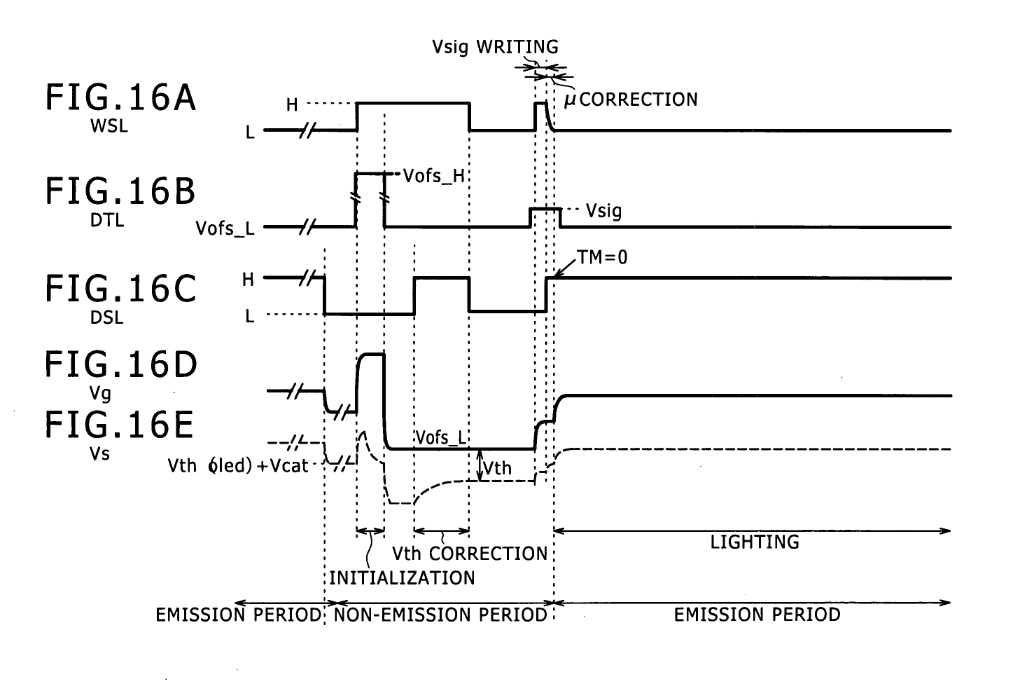

FIGS. 15A, 15B, 15C, 15D, and 15E and FIGS. 16A, 16B, 16C, 16D, and 16E show relation between driving signal waveforms and potential changes of the driving transistor N2 with attention directed to a sub-pixel 81 on a certain horizontal line forming the pixel array section 63. Incidentally, FIGS. 15A to 15E correspond to the operation of a horizontal line located in a first row, and FIGS. 16A to 16E correspond to the operation of a horizontal line located in a last row. A difference between the two operations is a difference between the lengths of waiting times T1 and TM to a lighting period appearing after an end of a non-emission period, as later described.

FIG. 15A and FIG. 16A show the driving waveform of a writing control line WSL corresponding to the sub-pixel 81 of interest.

FIG. 15B and FIG. 16B show the driving waveform of a signal line DTL. FIG. 15C and FIG. 16C show the driving waveform of a corresponding power supply control line DSL. FIG. 15D and FIG. 16D show the waveform of the gate potential Vg of the driving transistor N2. FIG. 15E and FIG. 16E show the waveform of the source potential Vs of the driving transistor N2.

As shown in FIGS. 15A to 15E and FIGS. 16A to 16E, the driving operation of the organic EL panel module 61 can be divided into a driving operation in a non-emission period and a driving operation in an emission period.

An initializing operation, an operation of writing a signal potential Vsig to the sub-pixel 81, and an operation of correcting variations in characteristics of the driving transistor N2 (threshold value correcting operation and mobility correcting operation) are performed in the non-emission period.

An operation of lighting the organic EL element OLED on the basis of the signal potential Vsig written in the non-emission period and an operation of temporarily stopping the lighting (that is, an extinguishing operation) are performed in the emission period. In the present embodiment, timing in which the extinguishing operation is performed and a period length for which the extinguishing operation is performed are set so as to differ in each horizontal line. This is because there is a need to accommodate a difference between the scan speed of a pulse signal giving a lighting period and the scan speed of a control pulse giving non-emission period control timing.

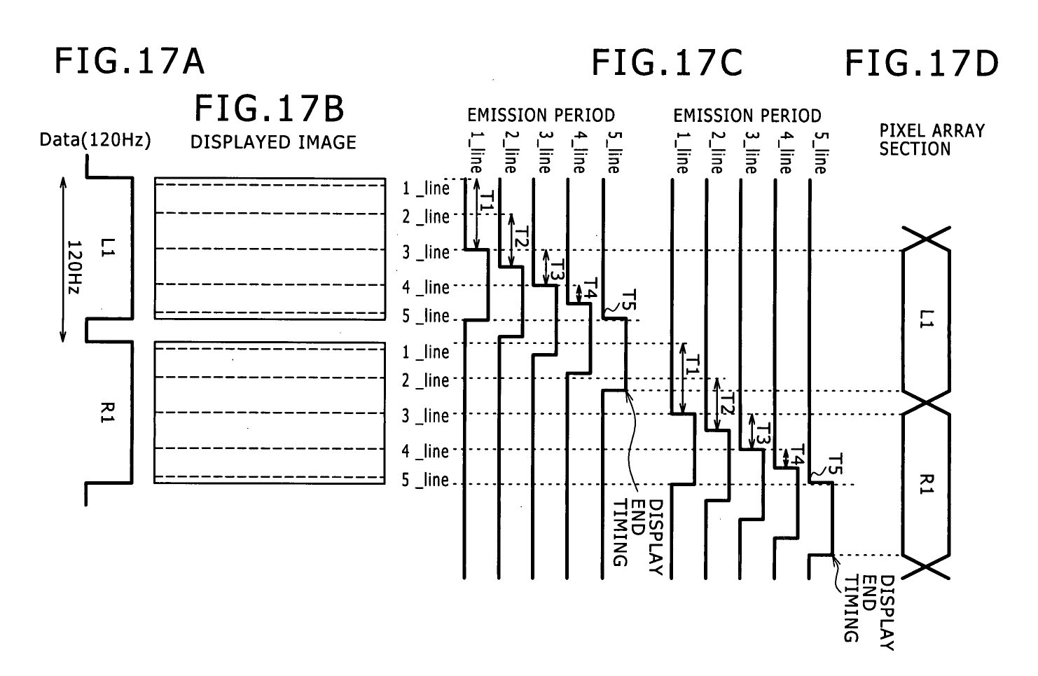

FIGS. 17A, 17B, 17C, and 17D show relation between waiting times provided for this speed adjustment and horizontal lines. Incidentally, FIGS. 17A to 17D represent a case where the number of horizontal lines is “5” in order to clarify correspondences. Incidentally, FIG. 17A shows timing of input of an image L for the left eye and an image R for the right eye. FIG. 17B shows correspondences between input image data and the horizontal lines. The positions of broken lines correspond to horizontal lines 1 to 5.

FIG. 17C shows relation between waiting times T1 to T5 from a time of an end of the non-emission period to a start of lighting in each horizontal line. As is understood from the figure, the waiting time T1 of horizontal line 1 where the lighting period starts first from the time of an end of the non-emission period is the longest, and the waiting time T5 of horizontal line 5 where the lighting period starts last is a minimum (including zero). Incidentally, horizontal lines 2, 3, and 4 are assigned waiting times T2, T3, and T4 obtained by equally dividing a difference between T1 and T5.

Such waiting times T can be set freely because lighting start timing and lighting period length in the organic EL panel module can be set freely by the control of the power supply control line DSL.

FIG. 17D shows timing of display of an image L for the left eye and an image R for the right eye. As shown in FIG. 17D, the display periods of the image L for the left eye and the image R for the right eye do not overlap each other. A vacant time is secured between display periods. This vacant time is used for an operation of opening and closing the liquid crystal shutter. In the case of FIGS. 17A to 17D, a shutter changing signal is generated with timing of an end of a lighting period (display period) of a horizontal line 5 as a trigger. Thus using timing of an end of a display period as a trigger can maximize the time length secured for the operation of opening and closing the liquid crystal shutter.

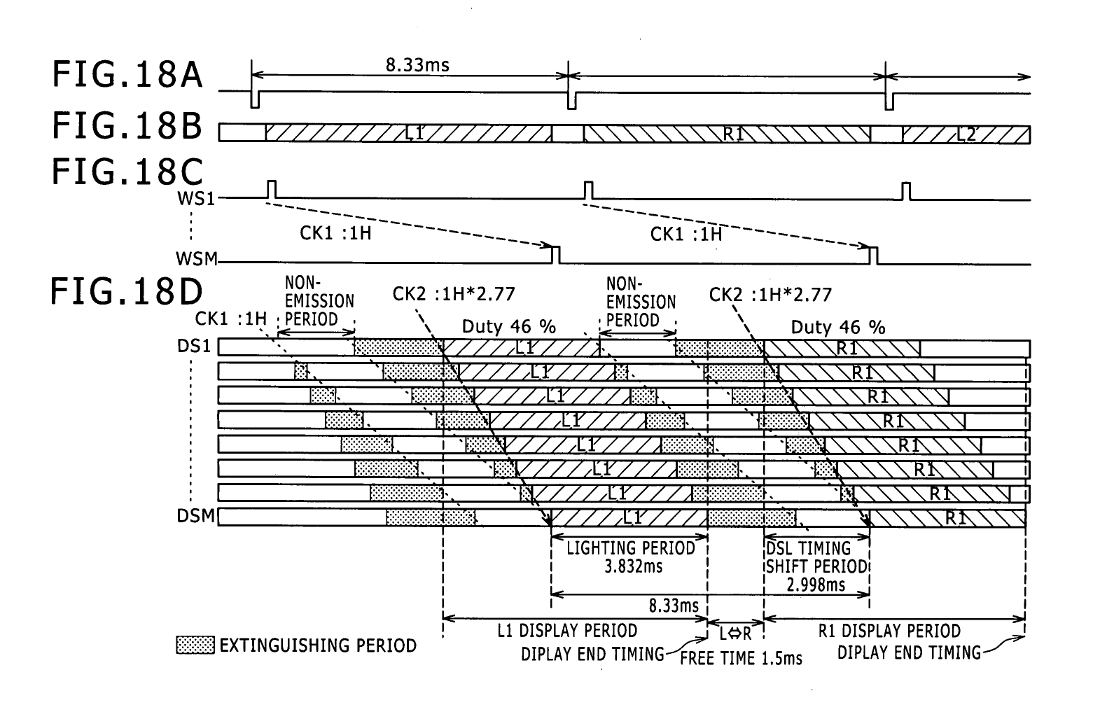

FIGS. 18A, 18B, 18C, and 18D show the relation of the above-described driving timing by a concrete example of numerical values. FIG. 18A is a waveform chart of a vertical synchronizing pulse giving one frame period. In the present embodiment, the vertical synchronizing pulse is given so as to display 120 frames in one second. Thus, in the present embodiment, a period length (a frame length) from a vertical synchronizing pulse to a vertical synchronizing pulse is 8.33 ms.

FIG. 18B is a diagram showing an image stream. FIG. 18B shows an image L1 for the left eye and an image R1 for the right eye which images form a first frame and a part of an image L2 for the left eye which image forms a second frame. As shown in FIG. 18B, each frame image is input between a vertical synchronizing pulse and a vertical synchronizing pulse.

FIG. 18C is a diagram showing the scan operation of a control pulse for driving the writing control line WSL. As shown in FIG. 18C, the control pulse is shift-driven in a line-sequential manner on the basis of the first shift clock CK1. In the present embodiment, the horizontal scanning clock is used as the first shift clock CK1.

FIG. 18D is a diagram of assistance in explaining relation of arrangement of non-emission periods of each horizontal line and lighting periods and extinguishing periods in emission periods. In FIG. 18D, outline sections are non-emission periods. In FIG. 18D, filled-in sections are extinguishing periods. On the other hand, diagonally hatched sections are lighting periods. As shown in FIG. 18D, extinguishing periods are arranged before and after a lighting period. The length of the extinguishing period provided before the lighting period as one of the extinguishing periods is the waiting time T described above.

As shown in FIG. 18D, the waiting times T of the horizontal lines include the longest waiting time T1 of horizontal line 1 as the first row and the shortest waiting time TM of horizontal line M as the last row. Incidentally, the extinguishing periods provided after the lighting periods conversely include the shortest extinguishing period of horizontal line 1 as the first row and the longest extinguishing period of horizontal line M as the last row. The extinguishing periods are thus arranged before and after the lighting periods to make the length of the lighting periods of each horizontal line the same length, that is, to prevent a luminance difference between horizontal lines.

In the case of FIG. 18D, the scan speed of the lighting periods (that is, the second shift clock CK2) is 2.77 times that of the first shift clock CK1. This relation is also understood from a fact that the slope of a thick broken line arrow indicating the slope of the lighting periods is steeper than the slope of a boundary line of the non-emission periods shown by outlines. This relation exerts an effect of compressing the display period of a frame image (period from a start of lighting in the first row to an end of lighting in the last row). In the present embodiment, the length of a lighting period of each horizontal line is 46% of one frame period, and is 3.832 ms.

In addition, a free time of 1.5 ms is secured between the display period of the image L1 for the left eye and the image R1 for the right eye. Incidentally, it suffices to secure only an amount of time necessary to control the opening and closing of the liquid crystal shutters as the free time. Thus, the length of the lighting periods and the scan speed (second shift clock CK2) can be adjusted freely so long as a minimum necessary free time is secured. Incidentally, timing of a start of this vacant time is a period of output of a display changing signal.

### (c) Details of Driving Operation

Detailed description will be made below of driving states within the sub-pixel. Incidentally, the driving timing and changes in potential states of the driving transistor N2 will be described with reference to FIGS. 15A to 15E and FIGS. 16A to 16E described above.

### (c-1) Lighting Operation within Emission Period

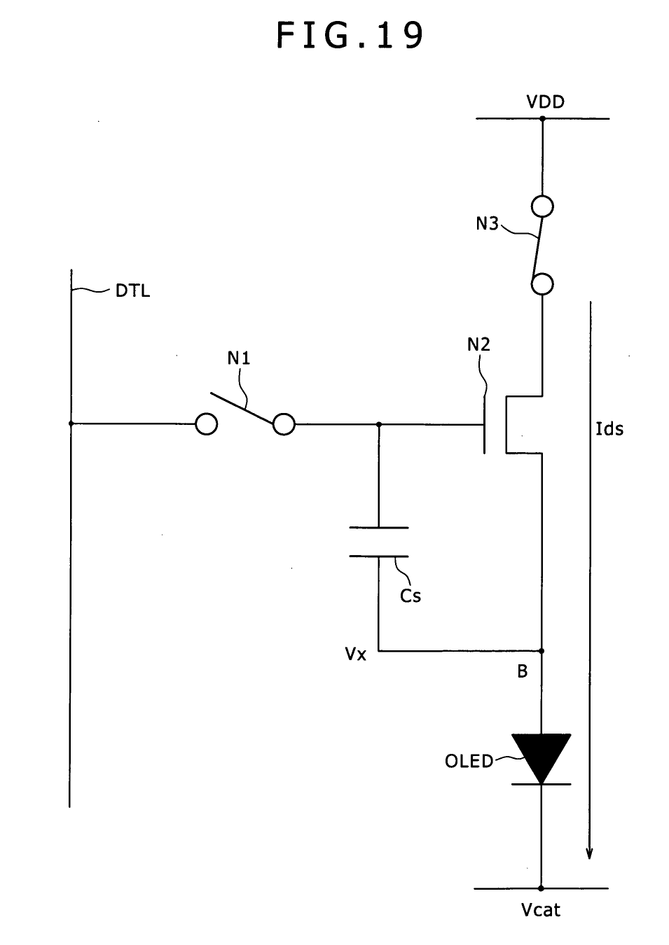

FIG. 19 shows a state of operation within the sub-pixel in an emission period. At this time, the writing control line WSL is at an L-level, and the sampling transistor N1 is controlled to be in an off state. Thus, the gate electrode of the driving transistor N2 is controlled to be in a floating state.

On the other hand, the power supply control line DSL is at an H-level, and the power supply controlling transistor N3 is controlled to be in an on state. The driving transistor N2 is thereby controlled to be in a state of operating in a saturation region. That is, the driving transistor N2 operates as a constant-current source that supplies a driving current corresponding to a voltage retained by the storage capacitor Cs to the organic EL element OLED. Thus, the organic EL element OLED emits light at a luminance corresponding to a pixel gradation. This operation is performed for all sub-pixels 51 in the emission period.

### (c-2) Extinguishing Operation within Non-Emission Period

After the emission period ends, a non-emission period begins. An operation of extinguishing the organic EL element OLED is performed first in the non-emission period.

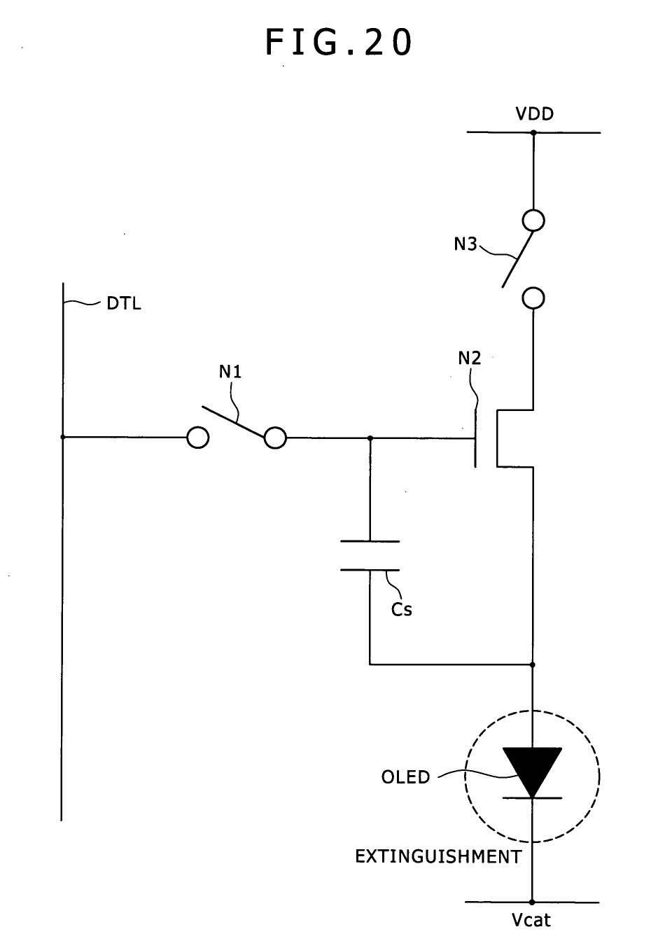

FIG. 20 shows a state of operation within the sub-pixel at a time of extinguishing operation. In the extinguishing operation, the power supply control line DSL is changed to an L-level, and the power supply controlling transistor N3 is controlled to be off. Incidentally, the off state of the sampling transistor N1 is still maintained.

This operation stops the supply of the driving current to the organic EL element OLED. With this, the organic EL element OLED as a current-driven element is extinguished. A voltage across the organic EL element OLED is simultaneously lowered to a threshold voltage Vth(oled). The source potential Vs of the driving transistor N2 is lowered to a potential obtained by adding the threshold voltage Vth(oled) to a cathode potential Vcat. In addition, with the decrease in the source potential, the gate potential Vg of the driving transistor N2 is also lowered. Incidentally, the storage capacitor Cs at this point in time still retains the gradation information of a previous frame.

### (c-3) Initializing Operation within Non-Emission Period

An initializing operation for initializing the gradation information of the previous frame is performed next.

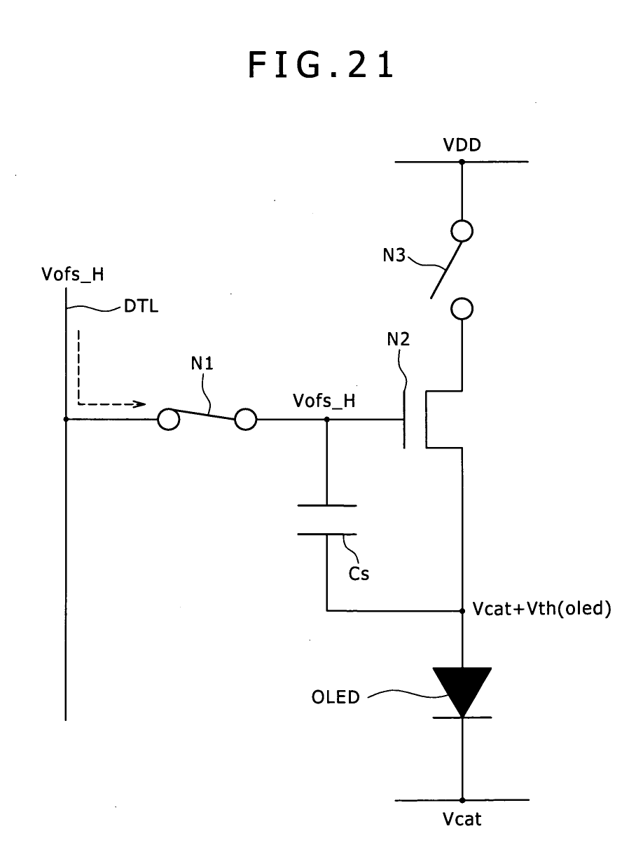

FIG. 21 shows a state of operation within the sub-pixel at a time of the initializing operation. When initializing timing arrives, the writing control line WSL is controlled to an H-level, and the sampling transistor N1 is changed to an on state. In addition, the initializing potential Vofs_H is applied to the signal line DTL in synchronism with the on operation of the sampling transistor N1. The initializing potential Vofs_H is thereby written to the gate potential Vg of the driving transistor N2 (FIG. 15D and FIG. 16D).

With a rise in the gate potential Vg, the source potential Vs of the driving transistor N2 also rises (FIG. 15E and FIG. 16E). That is, the source potential Vs becomes higher than the potential obtained by adding the threshold voltage Vth(oled) to the cathode potential Vcat. The organic EL element OLED is thereby set in an on state. However, because the power supply controlling transistor N3 remains in an off state, the organic EL element OLED operates in such a manner as to extract a charge from the source electrode of the driving transistor N2. The source potential Vs of the driving transistor N2 soon changes to Vcat+Vth(oled) again.

As a result, a voltage given by a difference between “Vofs_H” and “Vcat+Vth(oled)” (that is, an initializing voltage) is written to the storage capacitor Cs. This operation is the initializing operation.

Incidentally, as described above, the organic EL element OLED is set in a state of being able to emit light momentarily in the process of the initializing operation. However, image quality is not affected because even if the organic EL element OLED emits light, the luminance is low and the emission period is very short.

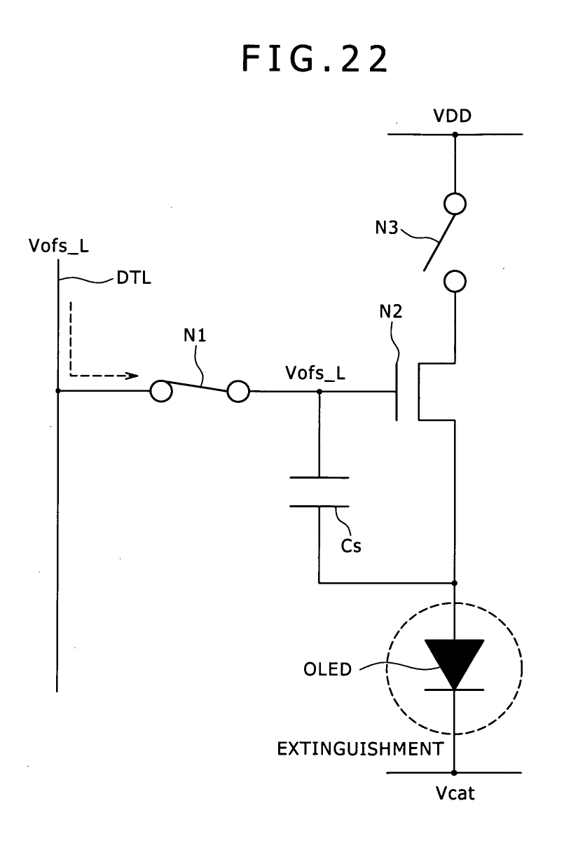

After the initializing voltage is written to the storage capacitor Cs, the potential of the signal line DTL changes from the initializing potential Vofs_H to the threshold value correcting potential Vofs_L. FIG. 22 shows a state of operation within the sub-pixel at this time. At this time, the sampling transistor N1 remains controlled to be on. The gate potential Vg of the driving transistor N2 is thereby lowered from the initializing potential Vofs_H to the threshold value correcting potential Vofs_L (FIG. 15D and FIG. 16D).

The source potential Vs of the driving transistor N2 is also lowered in such a manner as to be interlocked with the potential change of the gate potential Vg (FIG. 15E and FIG. 16E). This is because the initializing voltage is retained in the storage capacitor Cs. However, at the time of the lowering, the voltage retained by the storage capacitor Cs is slightly compressed from the initializing voltage. Incidentally, the voltage retained by the storage capacitor Cs at the time of an end of the initialization is sufficiently larger than the threshold voltage Vth of the driving transistor N2. As a result of the above operation, a preparation for correcting variation in threshold voltage Vth of the driving transistor N2 is completed.

### (c-4) Threshold Value Correcting Operation within Non-Emission Period

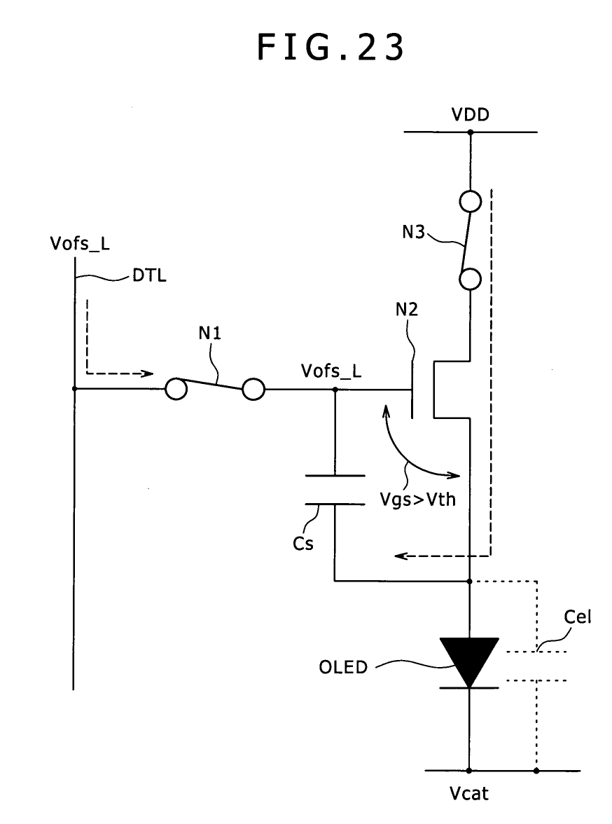

A threshold value correcting operation is started next. FIG. 23 shows a state of operation within the sub-pixel at the time of the threshold value correcting operation. The threshold value correcting operation is started by controlling the power supply control line DSL at an H-level, and performing the on control of the power supply controlling transistor N3.

At the time of the start, the gate-to-source voltage Vgs of the driving transistor N2 is wider than the threshold voltage Vth in consideration of variations. Thus, with the on control of the power supply controlling transistor N3, the driving-transistor N2 is also changed to an on state.

With this, a current starts flowing through the driving transistor N2 so as to charge the storage capacitor Cs and a capacitive component parasitic on the organic EL element OLED.

With this charging operation, the source potential Vs of the driving transistor N2 rises gradually. Incidentally, the gate potential Vg of the driving transistor N2 is fixed at the threshold value correcting potential Vofs_L. Thus, during the on control of the power supply controlling transistor N3, the gate-to-source voltage Vgs of the driving transistor N2 is gradually reduced from the initializing voltage (FIGS. 15D and 15E and FIGS. 16D and 16E).

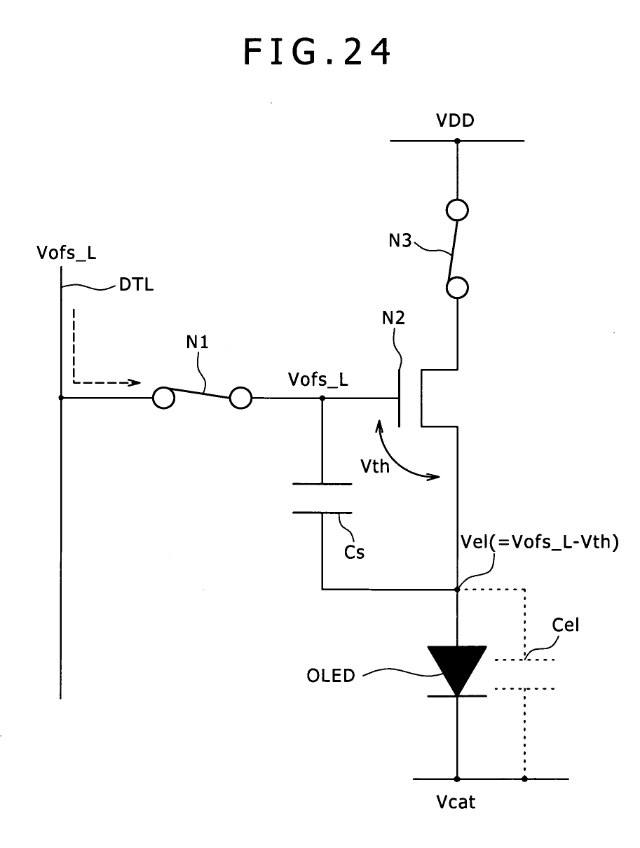

The driving transistor N2 soon performs a cutoff operation automatically when the gate-to-source voltage Vgs of the driving transistor-N2 reaches the threshold voltage Vth. FIG. 24 shows a state of operation within the sub-pixel when the driving transistor N2 cuts off automatically. At this time, the writing of the threshold value correcting potential Vofs_L to the gate electrode of the driving transistor N2 is continued. The source potential Vs of the driving transistor N2 is given by Vofs_L−Vth. The threshold value correcting operation is thereby completed.

Incidentally, “Vofs_L−Vth” is set to be a potential lower than “Vcat+Vth(oled).” Therefore the organic EL element OLED maintains the extinguished state also at this time.

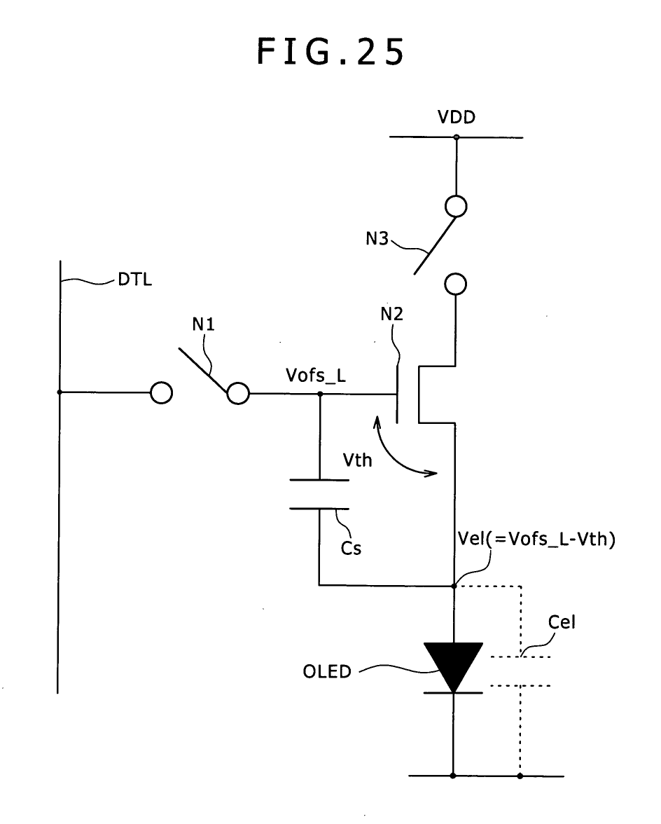

When the threshold value correcting operation is completed, as shown in FIG. 25, the sampling transistor N1 and the power supply controlling transistor N3 are simultaneously controlled to be off. At this time, the driving transistor N2 and the organic EL element OLED are both in an off state.

Ignoring the effect of an off current, the gate potential Vg and the source potential Vs of the driving transistor N2 continue maintaining a potential state at the time of completion of the threshold value correcting operation.

### (c-5) Signal Potential Writing Operation within Non-Emission Period

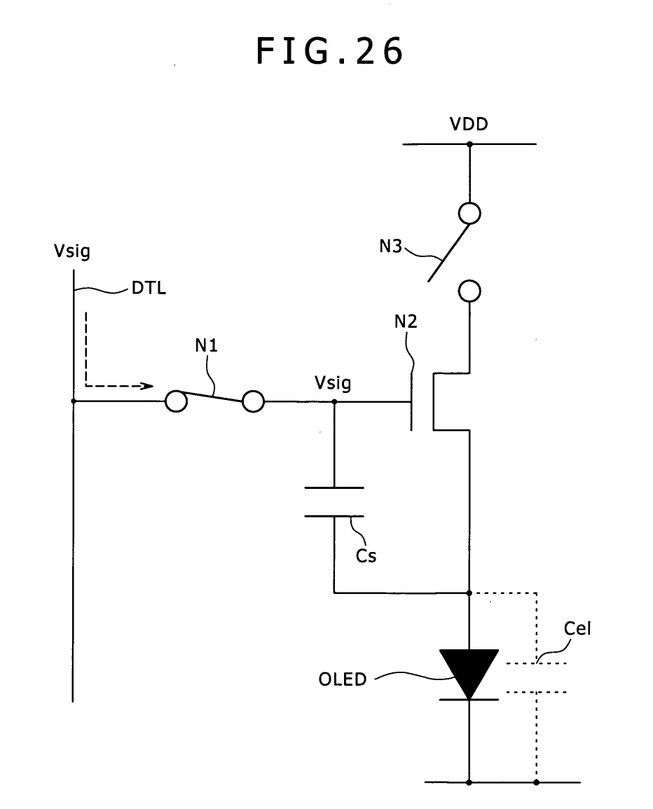

An operation of writing a signal potential Vsig is started next. FIG. 26 shows a state of operation within the sub-pixel when the operation of writing the signal potential Vsig is performed. In the present embodiment, this operation is started by performing on control of the sampling transistor N1 with the power supply controlling transistor N3 controlled to be off.

Incidentally, the potential of the signal line DTL is changed to the signal potential Vsig before the sampling transistor N1 is changed to an on state (FIGS. 15A to 15C and FIGS. 16A to 16C).

With the start of this operation, the gate potential Vg of the driving transistor N2 rises to the signal potential Vsig (FIG. 15D and FIG. 16D). That is, the signal potential Vsig is written to the storage capacitor Cs. However, with the rise in the gate potential Vg, the source potential Vs of the driving transistor N2 also rises slightly (FIG. 15E and FIG. 16E).

When the signal potential Vsig is thus written, the gate-to-source voltage Vgs of the driving transistor N2 becomes larger than the threshold voltage Vth, and the driving transistor N2 changes to an on state. However, the driving transistor N2 does not pass a driving current because the power supply controlling transistor N3 is in an off state. Thus, the extinguished state of the organic EL element OLED is maintained.

### (c-6) Mobility Correcting Operation within Non-Emission Period

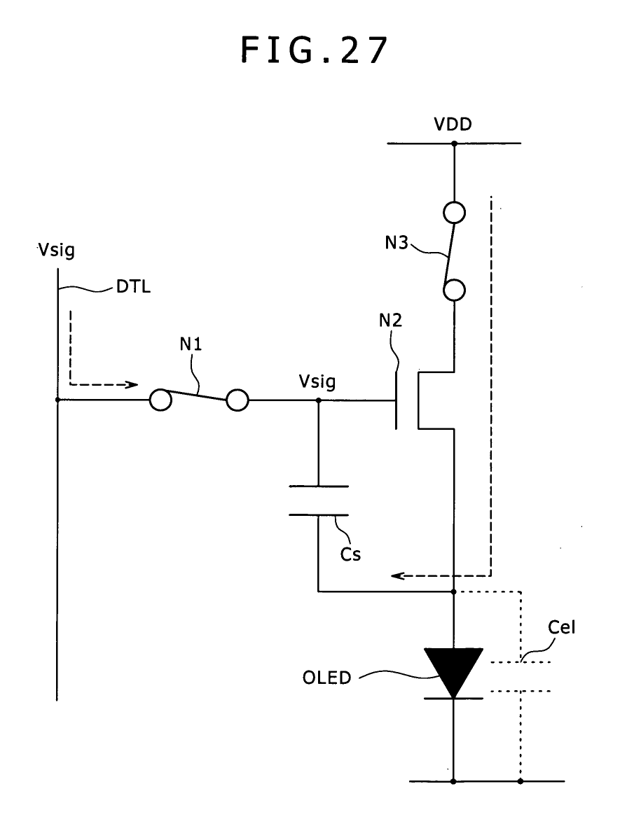

After the writing of the signal potential Vsig is completed, an operation of correcting variation in mobility μ of the driving transistor N2 is started. FIG. 27 shows a state of operation within the sub-pixel at the time of this operation. This operation is started by performing on control of the power supply controlling transistor N3.

With the on control of the power supply controlling transistor N3, a driving current of a magnitude corresponding to the gate-to-source voltage Vgs starts flowing through the driving transistor N2. This driving current flows so as to charge the storage capacitor Cs and the parasitic capacitance of the organic EL element OLED. That is, the source potential Vs of the driving transistor N2 rises. Incidentally, the extinguished state of the organic EL element OLED is maintained until the source potential Vs exceeds the threshold voltage Vth(oled) of the organic EL element OLED.

The higher the mobility μ of the driving transistor N2, the larger the driving current flowing in the mobility correcting period, and the lower the mobility p of the driving transistor N2, the smaller the driving current, even at the same gate-to-source voltage Vgs. Consequently, the higher the mobility p of the driving transistor N2, the smaller the gate-to-source voltage Vgs.

As a result of this correcting operation, the driving transistor N2 given a same pixel gradation supplies the driving current of a same magnitude to the organic EL element OLED irrespective of difference in mobility μ. That is, when the pixel gradation is the same, the light emission luminance of the sub-pixel 51 is corrected to be the same irrespective of difference in mobility μ.

In FIG. 15A and FIG. 16A, the waveform of a control pulse of the writing control line WSL used at the time of correcting the mobility μ is changed nonlinearly. This is to prevent an excess or a shortage of an amount of correction due to difference in magnitude of the pixel gradation.

When the on state of the power supply controlling transistor N3 is continued after completion of the mobility correcting operation, the source potential Vs of the driving transistor N2 rises to exceed the threshold voltage Vth(oled) of the organic EL element OLED, and the lighting of the organic EL element OLED is started.

However, in the present embodiment, the scan speed of a control pulse giving the lighting period is set higher than the scan speed of a control pulse giving the driving timing of the non-emission period. Hence, the point in time of a start of lighting needs to be delayed by the waiting time T determined for each horizontal line.

Accordingly, in the present embodiment, the power supply controlling transistor N3 is controlled to be off until the waiting time T for the corresponding horizontal line passes (FIG. 15C and FIG. 16C).

Incidentally, FIGS. 16A to 16E show the driving waveforms of the horizontal line corresponding to the last row (Mth row), and because the waiting time TM is set to zero, the lighting period starts from a mobility corrected state immediately.

### (c-7) Waiting Time Operation within Emission Period

After all the operations in the non-emission period are completed as described above, the operation of the emission period begins. As described above, all processes necessary to light the organic EL element OLED are completed when the non-emission period ends. However, as described above, the clock speed of the second shift clock CK2 used in the emission period is faster than that of the first shift clock CK1 used in the non-emission period.

Thus, the waiting time T before the organic EL element OLED is lit needs to be lengthened as the horizontal line becomes closer to the first row, as shown in FIG. 18D.

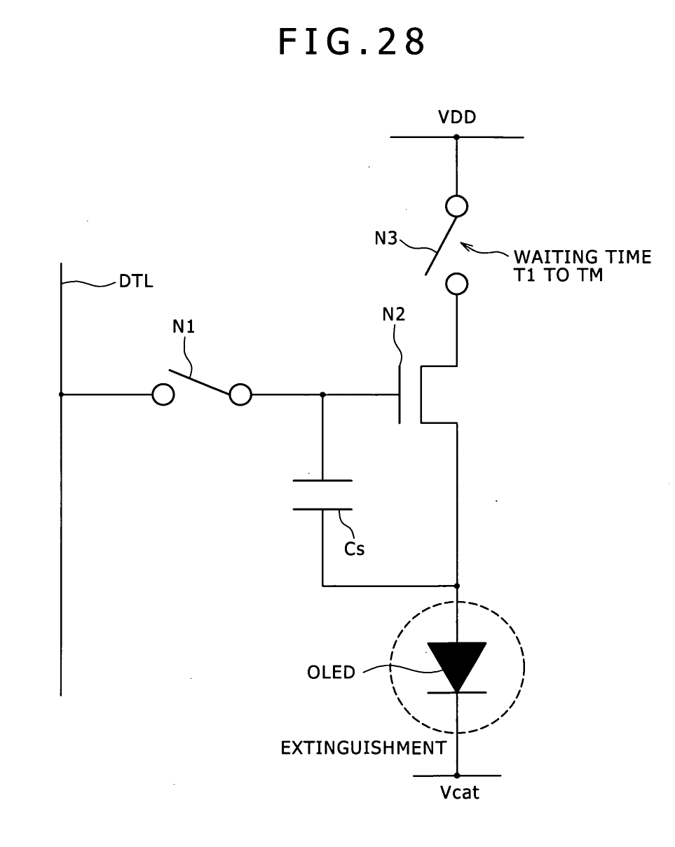

FIG. 28 shows a state of operation within the sub-pixel during the waiting time T. As shown in FIG. 28, the power supply controlling transistor N3 is controlled to be in an off state during the waiting time T determined for each horizontal line. Of course, the display of the horizontal line is black display during the waiting time.

### (c-8) Lighting Operation within Emission Period

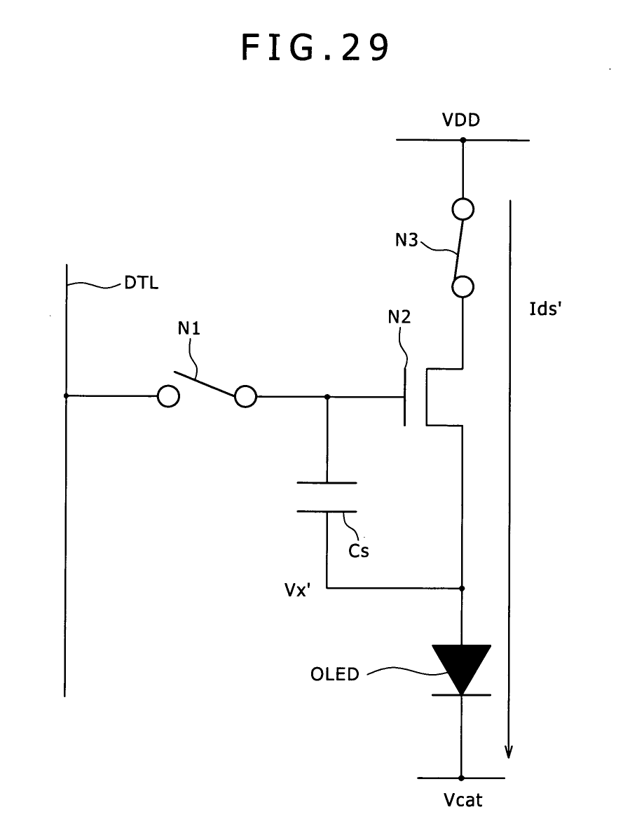

When the waiting time T set for each horizontal line has passed, as shown in FIG. 29, the power supply controlling transistor N3 is changed to an on state, and an operation of lighting the organic EL element OLED is started. Then, after the passage of a predetermined emission period, the power supply controlling transistor N3 is controlled to be turned off again, and thus set in a state of being ready for the process of a next frame.

### (C-3) Summary

As described above, in the this embodiment, the shutter changing signal for controlling the opening and closing of the liquid crystal shutter forming the eyeglasses 11 provided with the liquid crystal shutter is generated from the driving signal of the pixel array section 63. Thus, a synchronized state between timing of changing display frames and timing of outputting the shutter changing signal can be retained at all times irrespective of the time length of signal processing performed on image data. That is, phase adjustment by manual operation of a user is not necessary. Anyone can therefore enjoy three-dimensional images easily.

In addition, in the this embodiment, the display end timing extracting section 71 for generating the shutter changing signal is disposed on the organic EL panel module 61 or disposed within the display device 35. Thus a need for the stereo sync phase adjuster used in the existing system and the connection wiring between the stereo sync phase adjuster and the image reproducer can be eliminated. In addition, because the shutter changing signal is generated within the display device 35, a need for phase adjustment can be eliminated even when a general-purpose infrared emitter is used to emit infrared light.

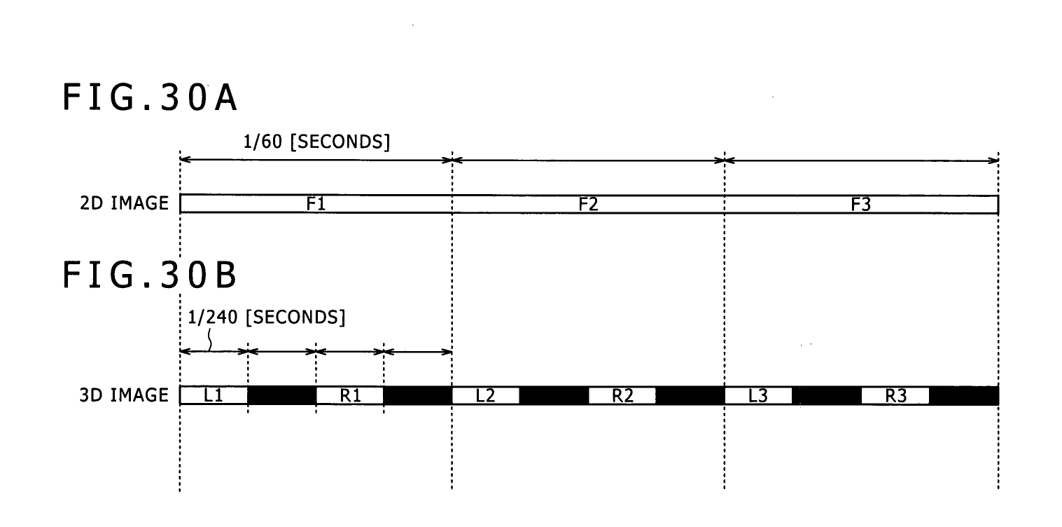

In addition, the driving system according to the this embodiment can greatly lower driving frequency as compared with the driving system disclosed in Japanese Patent Laid-Open No. 2007-286623 (hereinafter referred to as Patent Document 1). For reference, FIGS. 30A and 30B represent the driving system disclosed in Patent Document 1. Incidentally, FIGS. 30A and 30B show timing waveforms when a two-dimensional image and a three-dimensional image taken at a rate of 60 frames/second are displayed. Incidentally, FIG. 30A shows timing of processing of two-dimensional image data directing attention to a certain horizontal line, whereas FIG. 30B shows timing of processing of three-dimensional image data directing attention to a certain horizontal line.

Again, a period shown by an outline is a display period for an image for the left eye or an image for the right eye. A period shown by solid black is a display period for a black screen. This processing timing is arranged so as to be shifted for each horizontal line. Thereby the image for the left eye and the image for the right eye are prevented from being mixed with each other on the screen at a same time.

As is understood by reference to FIGS. 30A and 30B, the existing technique needs to drive the pixel array section at a rate of 240 frames/second to display an image of 60 frames/second.

On the other hand, the driving system according to the embodiment can lower the driving frequency to half that of the existing technique, as described with reference to FIGS. 14A and 14B. Specifically, a three-dimensional image taken or generated at a rate of 60 frames/second can be displayed on the screen at a rate of 120 frames/second.

Because the driving frequency is thus lowered, the operation margin of the pixel array section 63 can be increased. Therefore the manufacturing cost of the pixel array section 63 can be reduced. In addition, because the driving frequency is lowered, the operation speed of the timing generator and the driving circuit (for example a shift register) can also be lowered. From these viewpoints, the manufacturing cost of the organic EL panel module can be lowered.

In addition, in this embodiment, it is not necessary to provide a driving circuit for two-dimensional images and a driving circuit for three-dimensional images separately from each other. That is, the driving method according to the embodiment can display two-dimensional images and three-dimensional images in a single driving timing without a need to distinguish the two-dimensional images and the three-dimensional images from each other. Thus the layout area of the driving circuit can be made smaller than in the existing example. In addition, this embodiment eliminates a need for a circuit for determining the type of an image. Also from these viewpoints, it is possible to contribute to a decrease in cost of the organic EL panel module.

In addition, this embodiment eliminates a need to write an entire-surface black screen. Thus, the length of a lighting period in the embodiment can be set correspondingly longer than in the existing example. That is, by adopting the driving technique according to the embodiment, the brightness of the screen does not need to be sacrificed even at a time of display of a three-dimensional image.

### (D) Second Embodiment of Display Panel Module

In the foregoing first embodiment, a case where the length of lighting periods of each horizontal line is set fixedly is assumed. However, it is desirable to be able to vary the length of lighting periods of each horizontal line in consideration of display quality. In addition, when the lighting period length variable control technique and the technique of generating the shutter changing signal described above are combined with each other, three-dimensional images of high image quality can be viewed at all times.

Description in the following will be made of an organic EL panel module employing a technique of optimizing the lighting period length.

### (D-1) System Configuration

### (a) General Configuration

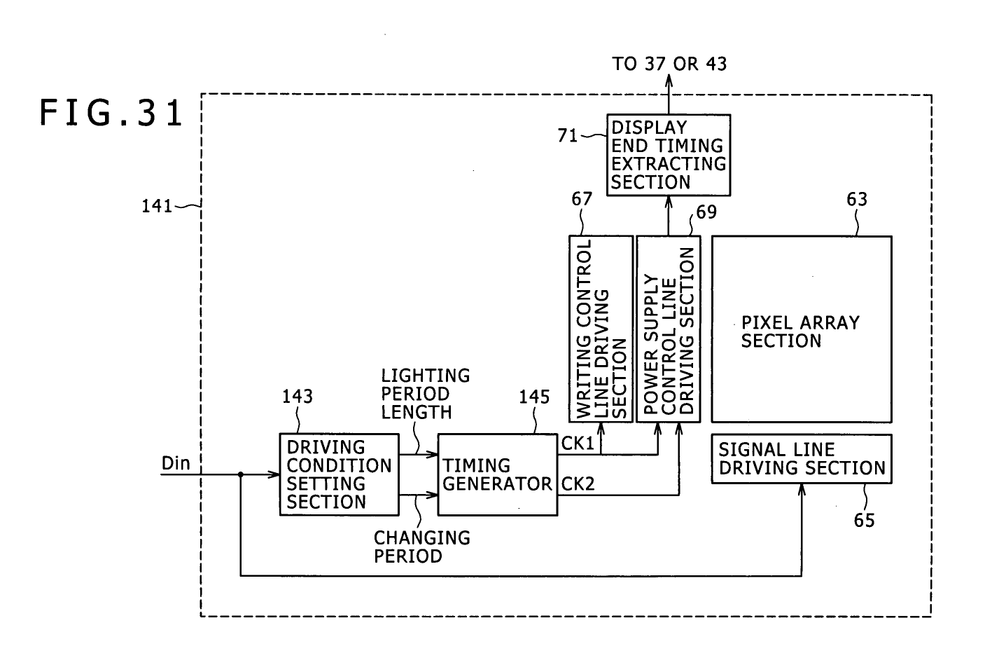

FIG. 31 shows an example of system configuration of an organic EL panel module 141 according to the present embodiment. Incidentally, in FIG. 31, parts corresponding to those of FIG. 7 are identified by the same reference numerals.

The organic EL panel module 141 shown in FIG. 31 includes a pixel array section 63, a signal line driving section 65, a writing control line driving section 67, and a power supply control line driving section 69 as a driving circuit for the pixel array section 63, a display end timing extracting section 71, a driving condition setting section 143, and a timing generator 145.

Description in the following will be made of the driving condition setting section 143 and the timing generator 145 as a configuration specific to the present embodiment.

### (b) Configuration of Driving Condition Setting Section

The driving condition setting section 143 is a circuit device for setting an optimum peak luminance for a display frame on the basis of pixel data Din, and setting the lighting period length and the scan speed of a second shift clock CK2 necessary for setting control of the lighting period length so as to achieve the peak luminance.

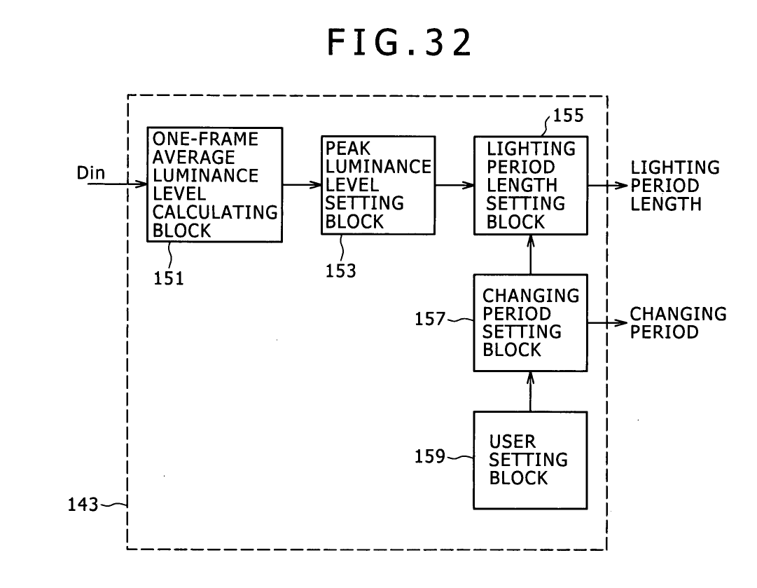

FIG. 32 shows an example of configuration of the driving condition setting section 143. The driving condition setting section 143 shown in FIG. 32 includes a one-frame average luminance level calculating block 151, a peak luminance level setting block 153, a lighting period length setting block 155, a changing period setting block 157, and a user setting block 159.

### (b-1) Configuration of One-Frame Average Luminance Level Calculating Block

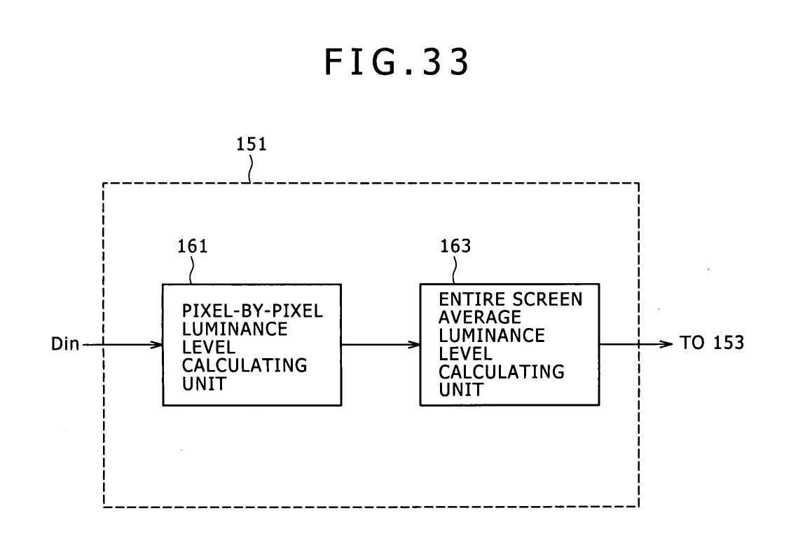

The one-frame average luminance level calculating block 151 is a processing device for calculating the average luminance level of each frame on the basis of the input pixel data Din. FIG. 33 shows an example of internal configuration of the one-frame average luminance level calculating block 151. The one-frame average luminance level calculating block 151 includes a pixel-by-pixel luminance level calculating unit 161 and an entire screen average luminance level calculating unit 163.

The pixel-by-pixel luminance level calculating unit 161 is a circuit device for calculating the luminance level of each pixel on the basis of the pixel data Din. The pixel data Din is generally input as primary color data. Therefore this circuit device converts the pixel data Din into luminance information in pixel units. The entire screen average luminance level calculating unit 163 is a circuit device for calculating the average value of luminance levels calculated for all pixels forming one frame. In the present embodiment, the average luminance level is sequentially calculated for each frame. Of course, the average luminance level may be calculated as an average value of a plurality of frames.

### (b-2) Configuration of Peak Luminance Level Setting Block

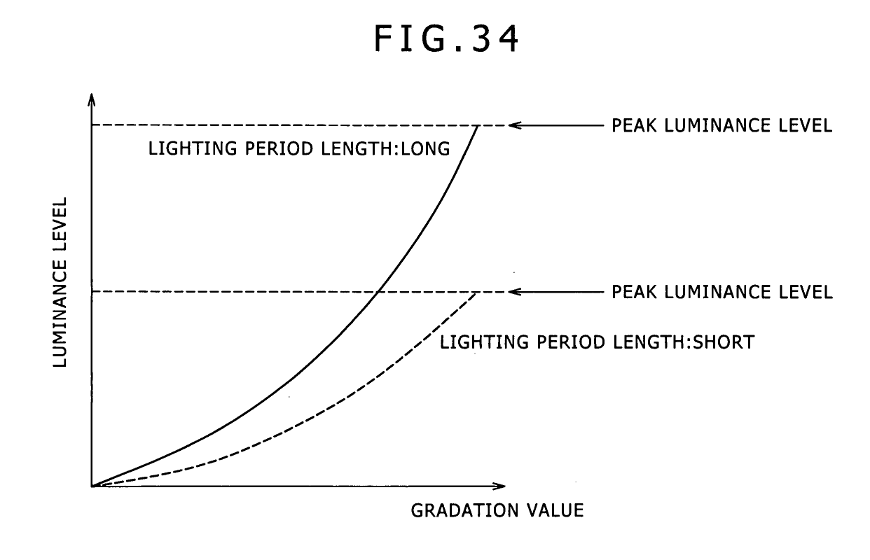

The peak luminance level setting block 153 is a circuit device for setting a peak luminance level corresponding to the calculated average luminance level. For example, the peak luminance level is set high in a frame image having a low average luminance level. Conversely, the peak luminance level is set low so as to reduce screen luminance in a frame image having a high average luminance level. FIG. 34 shows relation between peak luminance levels and each gradation luminance. As shown in FIG. 34, a peak luminance level means a luminance level corresponding to a maximum gradation value.

### (b-3) Configuration of Lighting Period Length Setting Block

The lighting period length setting block 155 is a circuit device for setting the lighting period length achieving the peak luminance level set sequentially within a range where display periods of adjacent frames do not overlap each other. The lighting period length setting block 155 determines a maximum value settable as a lighting period by internal processing, and retains the maximum value.

In this case, when the lighting period length corresponding to the sequentially set peak luminance level is equal to or less than the maximum value, the lighting period length setting block 155 sets the sequentially set peak luminance level as a value for the corresponding frame. On the other hand, when the lighting period length corresponding to the sequentially set peak luminance level is more than the maximum value, the lighting period length setting block 155 sets the retained maximum value as lighting period length for the corresponding frame.

The maximum value of settable lighting periods is determined so as to satisfy the following equation.

Lighting Period Maximum Value=Frame Data Length−Changing Period−DS Shift Period (Equation 1)

Incidentally, the changing period is a period necessary to change the opened and closed states of the liquid crystal shutters 27 and 29, as shown in FIG. 18D of the first embodiment. In general, liquid crystal shutter opening control takes a longer time than closing control. Of course, the necessary changing period depends on operation characteristics of the liquid crystal shutters 27 and 29 used by the user.

In the present embodiment, the changing period is given through the changing period setting block 157.

Incidentally, the changing period is input to the changing period setting block 157 through the user setting block 159, for example. Also in the present embodiment, suppose that the changing period is 1.5 ms, which is the same as in the first embodiment.

The DS shift period refers to a time allocated from a start of light emission of a horizontal line situated in a first row to a start of light emission of a horizontal line situated in a last row. The DS shift period in this case corresponds to the power supply control line (DSL) timing shift period in the case of FIG. 18D of the first embodiment. In the case of FIG. 18D, the length of the DS shift period is 2.998 ms.

Suppose in this case that the frame data length is 8.33 ms, that the changing period is 1.5 ms, and that the DS shift period is 2.998 ms. In this case, the maximum value of the lighting period length is obtained as 3.832 ms from (Equation 1). This lighting period corresponds to 46% of the frame data period. That is, FIGS. 18A to 18D represent an example where the lighting period length is the maximum value. Incidentally, the lighting period length setting block 155 stores the calculated maximum value of lighting periods, and uses the maximum value for a process of comparison with a lighting period corresponding to a peak luminance level.

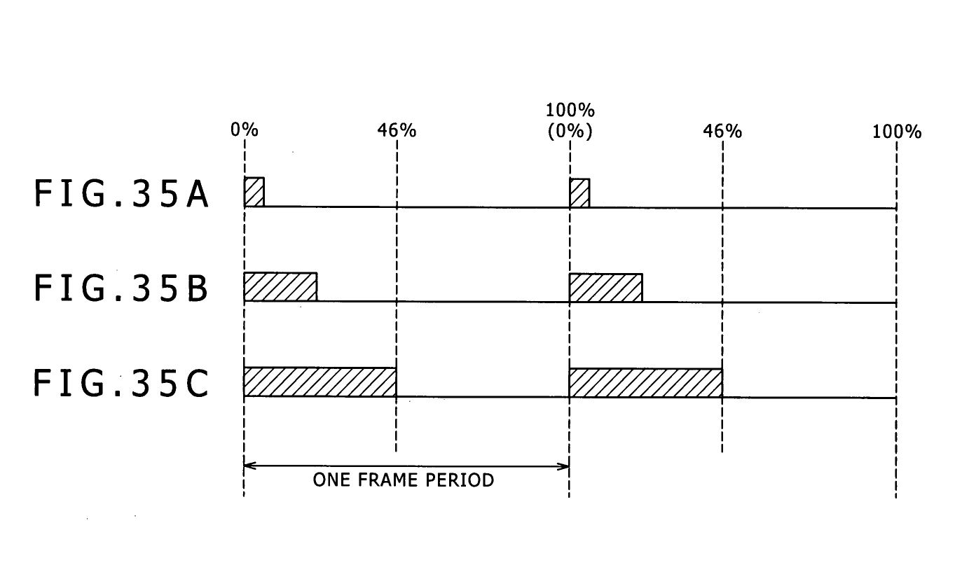

FIGS. 35A, 35B, and 35C show examples offsetting of the lighting period length by the lighting period length setting block 155. FIGS. 35A and 35B represent examples of setting when the lighting period length corresponding to a set peak luminance level is less than the maximum value. FIG. 35C represents an example of setting when the lighting period length corresponding to a set peak luminance level is equal to or exceeds the maximum value.

### (c) Configuration of Timing Generator

The timing generator 145 is a circuit device for supplying a timing signal to the above-described driving circuit and the like. The timing generator 145 supplies for example a horizontal scanning clock, a vertical scanning clock, a first shift clock CK1, a second shift clock CK2, a start pulse st and the like. Description in the following will be made of a method of setting the second shift clock CK2, which is set variably according to the lighting period length.

When information on the lighting period length and the changing period is input from the driving condition setting section 143 to the timing generator 145, the timing generator 145 performs arithmetic processing of the following equation to set a multiplication number of the second shift clock CK2 with respect to the first shift clock CK1.

Multiplication Number=Frame Data Period/(Frame Data Period−(Lighting Period+Changing Period)) (Equation 2)

As described above, the frame data period is 8.33 ms, and the changing period is 1.5 ms. When the lighting period length is given as the maximum value, the value is 3.832 ms.

When the value is substituted into (Equation 2), the multiplication number is 2.77. That is, it is understood that it suffices to set the second shift clock CK2 at a speed 2.77 times that of the first shift clock CK1. FIGS. 18A to 18D satisfy this condition.

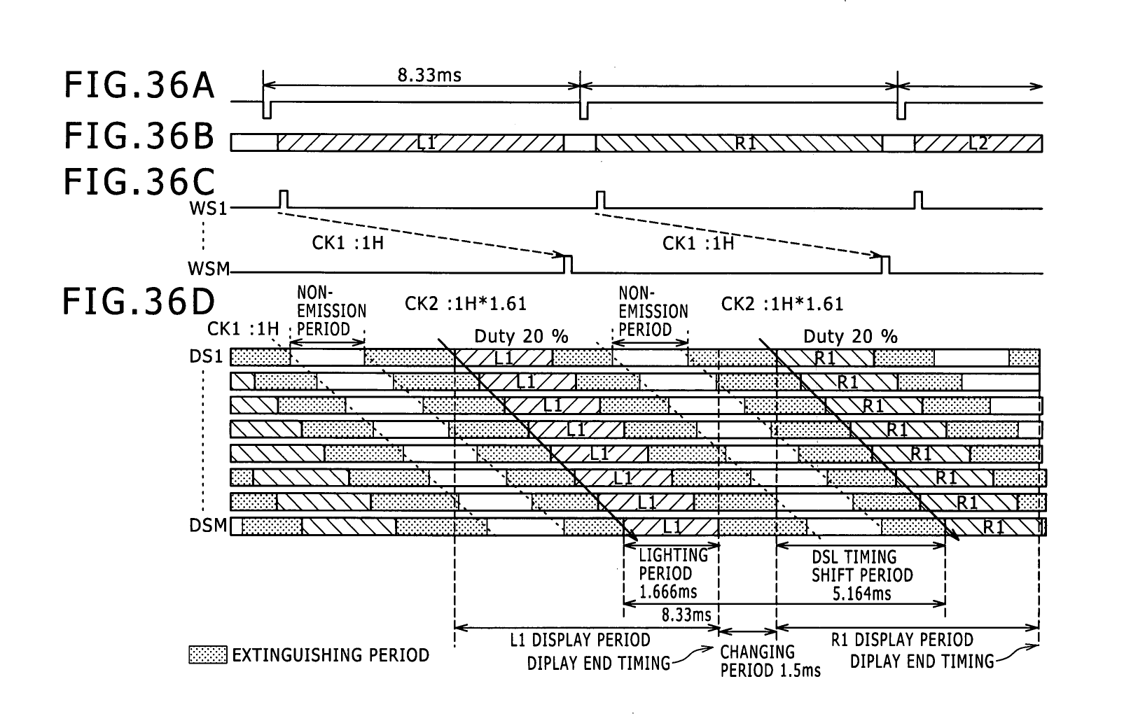

FIGS. 36A, 36B, 36C, and 36D show an example of driving operation when the lighting period length is given as 1.666 ms (that is, the lighting period is given as 20% of the frame data period). In this case, using (Equation 2), it is understood that it suffices to set the second shift clock CK2 at a speed 1.61 times that of the first shift clock CK1.

FIG. 36A is a waveform chart of a vertical synchronizing pulse giving one frame period. FIG. 36B is a diagram showing an image stream. FIG. 36C is a diagram showing the scan operation of a control pulse for driving the writing control lines WSL. FIG. 36D is a diagram of assistance in explaining arrangement relation between non-emission periods and lighting periods and extinguishing periods within emission periods of each horizontal line.

FIG. 36D shows that the lighting period length is shortened. In addition, as shown by a thick-line arrow in FIG. 36D, a straight line connecting lighting start timings has a gentler slope than in the case of FIG. 18D. This is due to a relatively low scan speed.

In addition, the lighting start timing of each horizontal line is delayed as compared with FIG. 18D, and therefore the waiting time T is lengthened as compared with FIG. 18D.

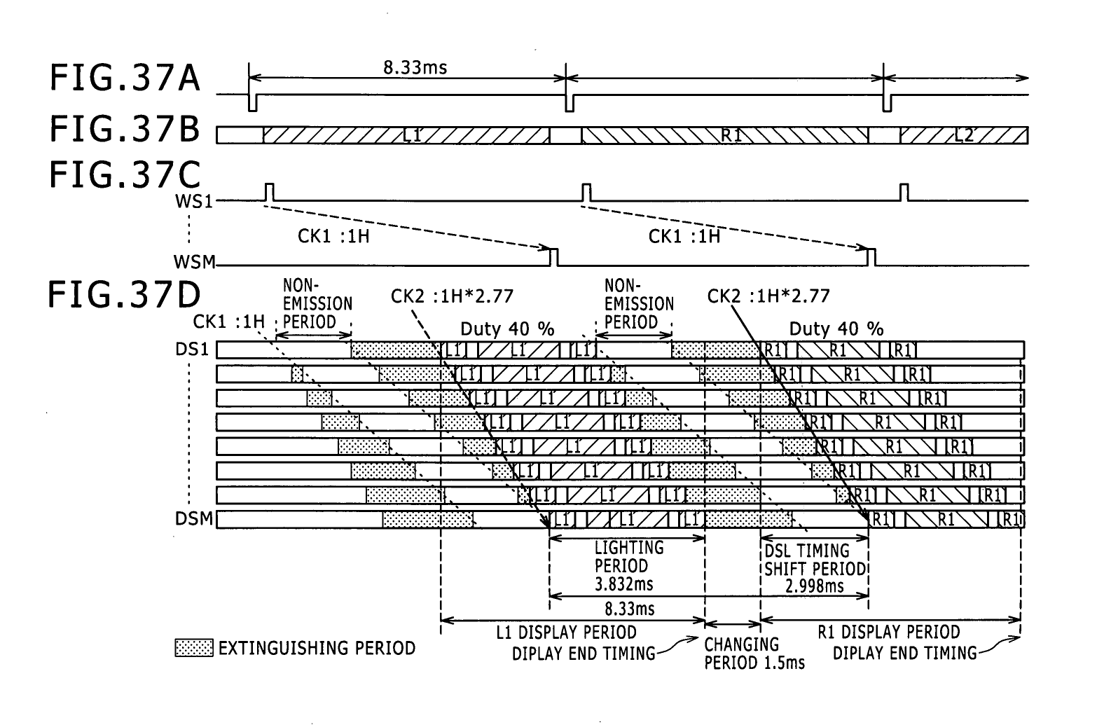

Another structure of lighting periods as shown in FIG. 37D is also considered. FIG. 37D represents a case where a lighting period is formed by a plurality of lighting periods. Incidentally, the structure shown in FIG. 37D is suitable to make a luminance distribution within the total lighting period close to a normal distribution by lengthening the period length of the lighting period situated at the center among the three lighting periods, and thereby suppress an image blur at a time of display of a moving image. When the total lighting period is thus formed by the plurality of lighting periods, it suffices to insert the total lighting period length into the foregoing equation.

Incidentally, the timing generator 145 generates the second shift clock CK2 having the clock speed set by using (Equation 2), and then supplies the second shift clock CK2 to the power supply control line-driving section 69. In addition, the timing generator 145 determines an optimum waiting time T from completion of mobility correction to a start of lighting for the first row on the basis of the second shift clock CK12, and outputs a start pulse st13 giving timing of output of a setting pulse in such a manner as to coincide with timing of completion of the waiting time. Similarly, the timing generator 145 outputs a start pulse st14 giving timing of output of a resetting pulse after the passage of a lighting period from the output of the start pulse st13.

In the present embodiment, the timing generator 145 sets the timings of output of the start pulse st13 and the start pulse st14 referring to a look-up table. Incidentally, suppose that the look-up table associates information on the timing of output of each pulse with a combination of a changing period and the speed or multiplication number of the second shift clock CK2, for example.

However, the timings of the start pulses st13 and st14 can also be obtained by operation. In addition, for example, the look-up table may associate information on the timing of output of each pulse with a combination of a changing period and a lighting period, and store the information.

### (D-2) Driving Operation and Summary

As described above, in the present embodiment, an optimum peak luminance level is set on the basis of the average luminance level of each frame regardless of whether the input image is a two-dimensional image or a three-dimensional image.

Next, a lighting period length reflecting the peak luminance level is set within a range where display periods of two adjacent frames do not overlap each other.

Thereafter, the second shift clock CK2 based on information on the set lighting period length and a changing period is supplied to the power supply control line driving section 69. The power supply control line driving section 69 outputs a control pulse for controlling the power supply controlling transistor N3 so as to retain the power supply controlling transistor N3 in an on state for the lighting period from lighting start timing for the horizontal line of the first row.

As a result, the lighting period of each frame can be set for a luminance level reflecting the contents of the input image. In particular, even when a three-dimensional image is displayed, it is possible to achieve even luminance control reflecting the contents of the display image while performing changing display of an image for the left eye and an image for the right eye. That is, the display quality of three-dimensional images can be enhanced. Of course, the display quality of two-dimensional images can also be improved.

In addition, even when the setting of the lighting period length is variably controlled within the display device, the shutter changing signal is generated on the basis of a driving signal (power supply line controlling signal) reflecting a change in the lighting period length. Thus, the liquid crystal shutters 27 and 29 can be automatically switching-controlled in optimum shutter timing at all times regardless of the variable control according to image contents.

### (E) Other Embodiments

### (E-1) Other Examples of Configuration of Display End Timing Extracting Section

The foregoing embodiment employs a configuration in which a branch line of wiring giving timing (reset timing) of an end of the emission period of the power supply line DSL corresponding to the last output row in the internal configuration of the power supply control line driving section 69 shown in FIG. 13 is input to the display end timing extracting section 71. That is, description has been made of a case where the display end timing extracting section 71 is formed as an independent device.

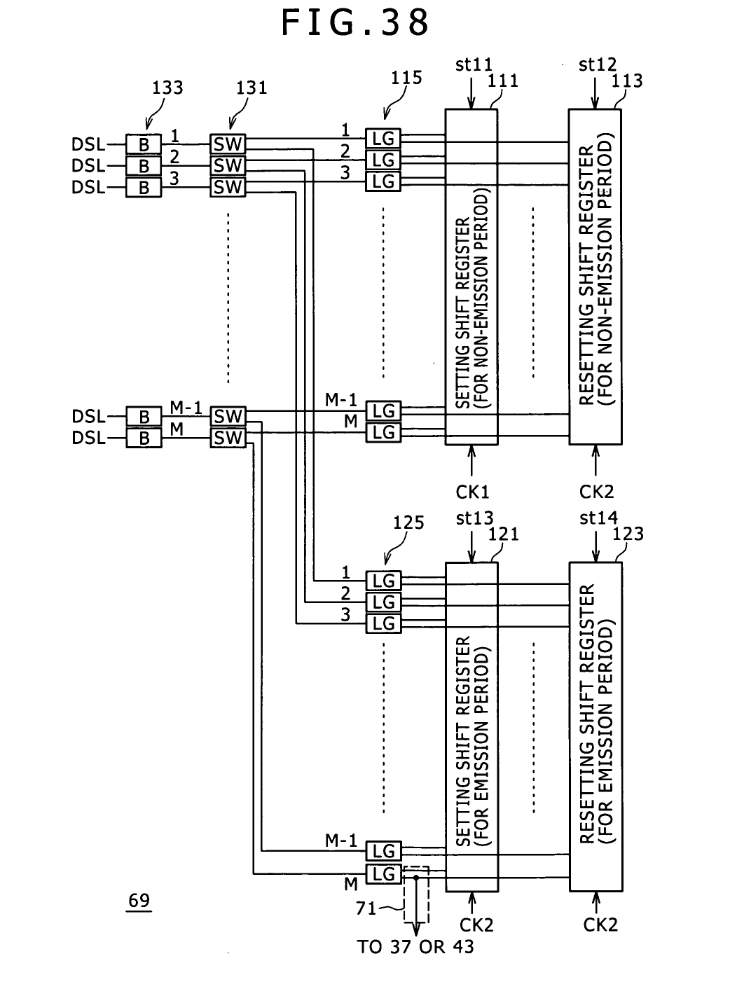

However, as shown in FIG. 38, the display end timing extracting section 71 may be realized as the branch line of the wiring. That is, a configuration in which an output waveform in the last stage of the resetting shift register 123 is directly input to the infrared light emitting section 37 or 43 may be adopted.

### (E-2) Other Disposition of Display Changing Signal Transmitting Section

In the foregoing embodiments, description has been made of a case where the infrared light emitting section 37 is provided separately from the organic EL panel module 61.

However, the infrared light emitting section 37 may also be mounted on the same panel as the organic EL panel module 61.

### (E-3) Other Configurations of Display Changing Signal Transmitting Section

In the foregoing embodiments, description has been made of a case where an infrared light emitting section is used to transmit the display changing signal to the user side.

However, radio communication techniques other than those using infrared rays can be applied to the transmission of the display changing signal.

### (E-4) Other Configurations of Shutter Mechanism

In the foregoing embodiments, description has been made of a case where liquid crystal shutters are attached to eyeglass-type wearable means worn by a user.

However, electronic devices other than liquid crystal shutters may be used as shutter mechanism.

### (C) Other Embodiments

### (E-5) Other Examples of Setting of Shift Clocks

In the foregoing embodiment, description has been made of a case where the clock speed of the second shift clock CK2 is set at 2.77 times the clock speed of the first shift clock CK1.

However, the clock speed ratio between the first shift clock CK1 and the second shift clock CK2 is not limited to this, of course.

### (E-6) Ratio of Lighting Period to One Frame

In the foregoing embodiment, description has been made of a case where the ratio of the lighting period is 46% of one frame.

However, the lighting period may have other ratios. Of course, the higher the ratio of the lighting period, the higher the luminance of the screen even at a same driving voltage VDD.

### (E-7) Waiting Time of Last Output Row

In the foregoing embodiment, description has been made of a case where the waiting time TM of the horizontal line where the operation of writing the signal potential Vsig is completed last is set at zero. However, the waiting time TM does not necessarily need to be set at zero.

### (E-8) Vacant Time

The foregoing embodiments suppose a case of one kind of wearable means used by a user.

However, there may be a case where a plurality of kinds of wearable means are used simultaneously. In this case, when the lengths of all shutter changing times are not the same, it suffices to set the vacant time to a maximum value of the shutter changing times.

### (E-9) Other Structures of Sub-Pixel

In the foregoing embodiment, description has been made of a case where the sub-pixel 81 is formed with three N-channel thin film transistors.

However, the thin film transistors forming the sub-pixel 81 may be P-channel thin film transistors.

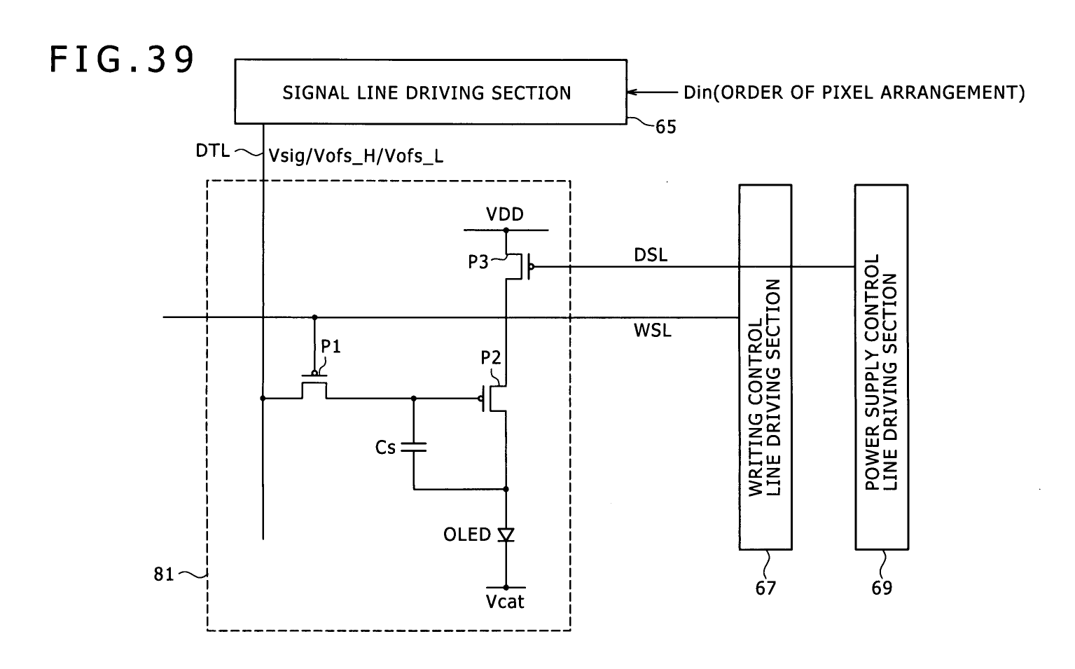

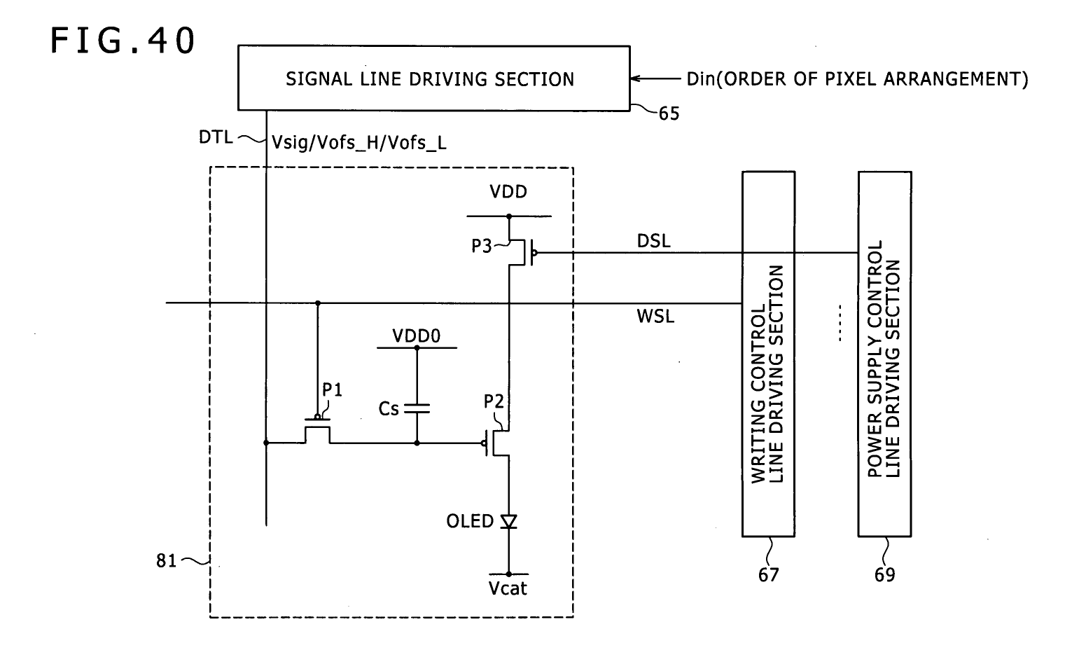

FIG. 39 and FIG. 40 show an example of a circuit of this kind. FIG. 39 represents an example in which only the thin film transistors are all replaced with P-channel thin film transistors with the relation of connection of the sub-pixel 81 according to the embodiment retained as it is. On the other hand, FIG. 40 represents an example of a circuit in which the connection of the storage capacitor Cs is changed. In the case of FIG. 40, one electrode of the storage capacitor Cs is connected to a fixed power supply line (VDDO).

In addition, the number of thin film transistors forming the sub-pixel 81 may be four or more, or two. The driving technique according to an embodiment of the present invention can be applied regardless of the circuit configuration of the sub-pixel 81 as long as the supply and the stopping of the driving power or driving current for each pixel can be controlled in horizontal line units.

### (E-10) Product Examples

### (a) System Configuration

The above description has been made of the panel structure and the driving method of the organic EL panel module alone. However, the above-described organic EL panel module is distributed also in product forms in which the organic EL panel module is mounted in various electronic devices. Examples of mounting the organic EL panel module in other electronic devices will be shown in the following.

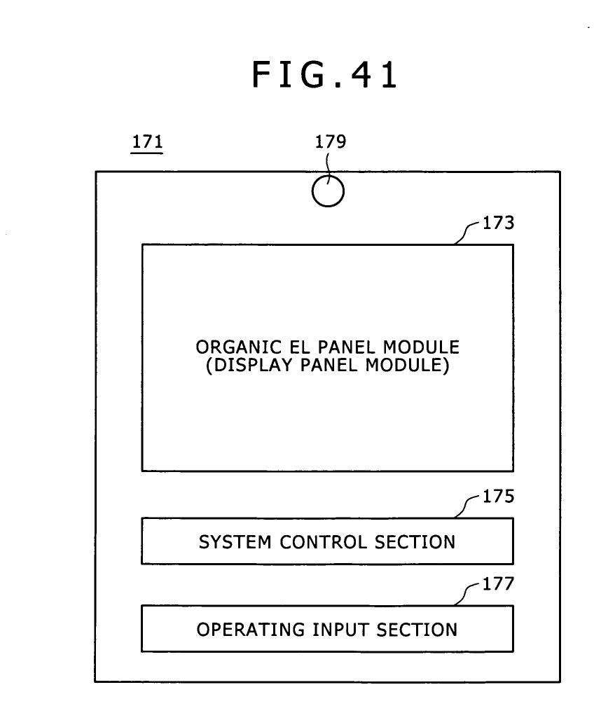

FIG. 41 shows an example of conceptual configuration of an electronic device 171. The electronic device 171 includes a display panel module 173 having the above-described driving circuit and the display end timing extracting section incorporated therein, a system control section 175, an operating input section 177, and a switching timing notifying device 179.

Details of processing performed in the system control section 175 differ depending on the product form of the electronic device 171. The operating input section 177 is a device for receiving an operating input to the system control section 175. For example a switch, a button, or another mechanical interface, a graphics interface or the like is used as the operating input section 177.

In addition, the switching timing notifying device 179 not only is attached integrally with the casing of the electronic device 171 as shown in FIG. 41, but also may be external to the casing of the electronic device 171 as an independent device.

### (b) Concrete Examples

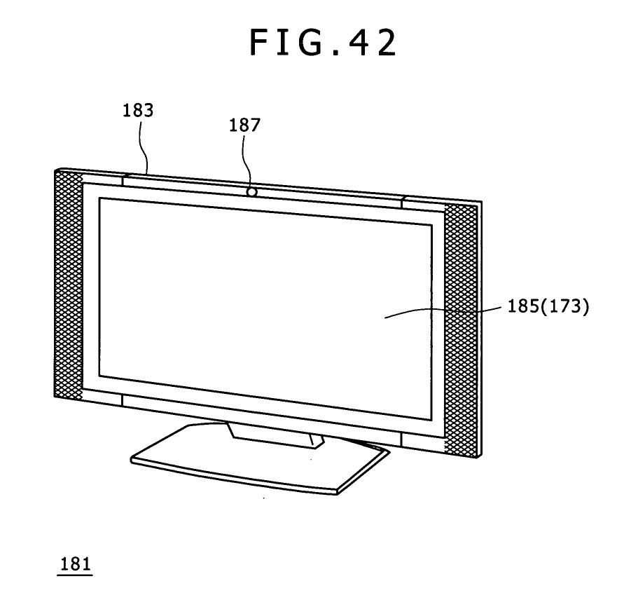

FIG. 42 shows an example of an external appearance when the electronic device is a television receiver. The television receiver 181 has a structure in which a display screen 185 and a switching timing notifying device 187 are arranged in the front surface of a casing 183. The part of the display screen 185 in this case corresponds to the organic EL panel module described in the embodiment.

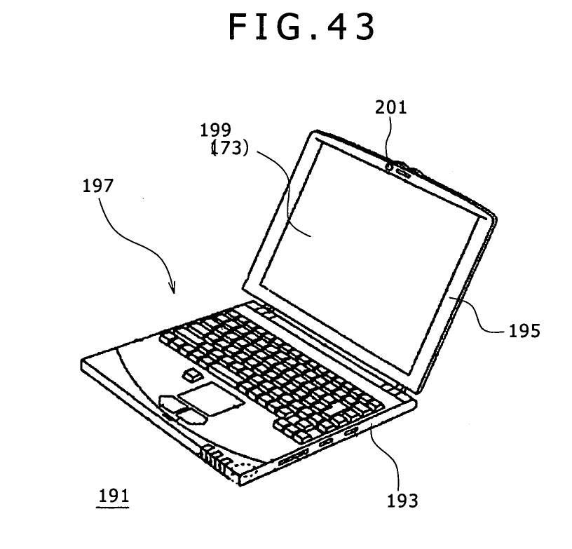

In addition, for example a computer is assumed as an electronic device of this kind. FIG. 43 shows an example of external appearance of a notebook computer 191.

The notebook computer 191 includes a lower side casing 193, an upper side casing 195, a keyboard 197, a display screen 199, and a switching timing notifying device 201. Of these parts, the part of the display screen 199 in this case corresponds to the organic EL panel module described in the embodiment.

In addition to the above, a game machine, an electronic book, an electronic dictionary and the like are assumed as electronic devices.

### (E-11) Examples of Other Display Devices

In the foregoing embodiment, description has been made of a case where the invention is applied to an organic EL panel module.

However, the configuration of the power supply system circuit described above can be applied also to other display panel modules of an emissive type.

For example, the configuration of the power supply system circuit can be applied to display devices having LEDs arranged in the form of a matrix and display panel modules having light emitting elements of a diode structure arranged on a screen. For example, the configuration of the power supply system circuit can be applied also to inorganic EL panels.

### (E-12) Others

Various examples of modification of the foregoing embodiment can be considered without departing from the spirit of the invention. Various examples of modification and various examples of application created or combined on the basis of the description of the present specification can also be considered.

The present application contains subject matter related to that disclosed in Japanese Priority Patent Application JP 2008-264547 filed in the Japan Patent Office on Oct. 10, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional image system comprising:
a display device including a pixel array section having pixels arranged in a form of a matrix, a driving circuit section configured to drive said pixel array section to display an input image, and a display end timing extracting section configured to extract display end timing corresponding to a last output row of each frame from a driving signal of said driving circuit section when an image for a left eye and an image for a right eye, the image for the left eye and the image for the right eye corresponding to a binocular parallax, are displayed alternately in frame units in said pixel array section;
a transmitting section configured to transmit a display changing signal for the image for the left eye and the image for the right eye with the extracted display end timing as a trigger; and
wearable means including a receiving section configured to receive said display changing signal, a pair of shutter mechanisms disposed in front of eyes of a wearer, and a shutter driving section configured to drive said shutter mechanisms so as to enable only observation by the eye corresponding to an image being displayed on a basis of said display changing signal.

2. The three-dimensional image system according to claim 1,
wherein said driving circuit section operates in common driving timing set such that display periods of adjacent frames do not overlap each other when either of a two-dimensional image and a three-dimensional image is displayed.

3. The three-dimensional image system according to claim 2,
wherein said driving circuit section includes a first driving section configured to drive a signal line formed in said pixel array section, a second driving section configured to control writing of a potential appearing in said signal line to said pixel, and a third driving section configured to control supplying and stopping of one of a driving power and a driving current to said pixel,
said second driving section controls writing timing on a basis of a first scan clock, and
said third driving section controls timing of supply of one of said driving power and said driving current on a basis of a second scan clock having a higher speed than said first scan clock.

4. The three-dimensional image system according to claim 3,
wherein a waiting time from completion of writing of a signal potential to a start of lighting in each horizontal line is set such that
the waiting time of a first horizontal line in which the writing of a signal potential is completed first is longest,
the waiting time of a second horizontal line in which the writing of a signal potential is completed last is shortest, and
length of the waiting time of each horizontal line positioned between said first horizontal line and said second horizontal line is changed linearly according to positional relation to said first horizontal line and said second horizontal line.

5. The three-dimensional image system according to claim 4,
wherein said display end timing is extracted on a basis of timing of stopping supply of one of driving current and driving power to the last output row of said pixel array section.

6. The three-dimensional image system according to claim 4,
wherein said display end timing is extracted on a basis of timing of a start of output of an entire-surface black screen inserted at a time of changing between the image for the left eye and the image for the right eye.

7. A display device comprising:
a pixel array section having pixels arranged in a form of a matrix;
a driving circuit section configured to drive said pixel array section to display an input image;
a display end timing extracting section configured to extract display end timing corresponding to a last output row of each frame from a driving signal of said driving circuit section when an image for a left eye and an image for a right eye, the image for the left eye and the image for the right eye corresponding to a binocular parallax, are displayed alternately in frame units in said pixel array section; and
a transmitting section configured to transmit a display changing signal for the image for the left eye and the image for the right eye with the extracted display end timing as a trigger.

8. A shutter operation synchronizing device of a three-dimensional image system, said shutter operation synchronizing device comprising:
a display end timing extracting section configured to extract display end timing corresponding to a last output row of each frame from a driving signal of a driving circuit section when an image for a left eye and an image for a right eye, the image for the left eye and the image for the right eye corresponding to a binocular parallax, are displayed alternately in frame units in a pixel array section having pixels arranged in a form of a matrix; and
a transmitting section configured to transmit a display changing signal for the image for the left eye and the image for the right eye with the extracted display end timing as a trigger.

9. A shutter operation synchronizing method of a three-dimensional image system, said shutter operation synchronizing method comprising the steps of:
extracting display end timing corresponding to a last output row of each frame from a driving signal of a driving circuit section when an image for a left eye and an image for a right eye, the image for the left eye and the image for the right eye corresponding to a binocular parallax, are displayed alternately in frame units in a pixel array section having pixels arranged in a form of a matrix; and
transmitting a display changing signal for the image for the left eye and the image for the right eye with the extracted display end timing as a trigger.

10. An electronic device comprising:
a pixel array section having pixels arranged in a form of a matrix;
a driving circuit section configured to drive said pixel array section to display an input image;
a display end timing extracting section configured to extract display end timing corresponding to a last output row of each frame from a driving signal of said driving circuit section when an image for a left eye and an image for a right eye, the image for the left eye and the image for the right eye corresponding to a binocular parallax, are displayed alternately in frame units in said pixel array section;
a transmitting section configured to transmit a display changing signal for the image for the left eye and the image for the right eye with the extracted display end timing as a trigger;
a system control section configured to control operation of an entire system; and
an operating input section for said system control section.

11. A display device comprising:
pixel array means having pixels arranged in a form of a matrix;
driving circuit means for driving said pixel array section to display an input image;
display end timing extracting means for extracting display end timing corresponding to a last output row of each frame from a driving signal of said driving circuit section when an image for a left eye and an image for a right eye, the image for the left eye and the image for the right eye corresponding to a binocular parallax, are displayed alternately in frame units in said pixel array section; and
transmitting means for transmitting a display changing signal for the image for the left eye and the image for the right eye with the extracted display end timing as a trigger.

12. A shutter operation synchronizing device of a three-dimensional image system, said shutter operation synchronizing device comprising:
display end timing extracting means for extracting display end timing corresponding to a last output row of each frame from a driving signal of a driving circuit section when an image for a left eye and an image for a right eye, the image for the left eye and the image for the right eye corresponding to a binocular parallax, are displayed alternately in frame units in a pixel array section having pixels arranged in a form of a matrix; and
transmitting means for transmitting a display changing signal for the image for the left eye and the image for the right eye with the extracted display end timing as a trigger.

13. An electronic device comprising:
pixel array means having pixels arranged in a form of a matrix;
driving circuit means for driving said pixel array section to display an input image;
display end timing extracting means for extracting display end timing corresponding to a last output row of each frame from a driving signal of said driving circuit section when an image for a left eye and an image for a right eye, the image for the left eye and the image for the right eye corresponding to a binocular parallax, are displayed alternately in frame units in said pixel array section;
transmitting means for transmitting a display changing signal for the image for the left eye and the image for the right eye with the extracted display end timing as a trigger;
system control means for controlling operation of an entire system; and
operating input means for said system control section.
